(19) United States
(12) Patent Application Publication
(10) Pub. No.: US 2025/0047370 A1
(43) Pub. Date: Feb. 6, 2025

(54) COMMUNICATION METHOD AND APPARATUS

(71) Applicant: HUAWEI TECHNOLOGIES CO., LTD., Shenzhen (CN)

(72) Inventors: Ying CHEN, Hangzhou (CN); Yunfei QIAO, Hangzhou (CN); Yinggang DU, Shenzhen (CN); Jun WANG, Hangzhou (CN)

(21) Appl. No.: 18/926,606

(22) Filed: Oct. 25, 2024

Related U.S. Application Data
(63) Continuation of application No. PCT/CN2023/084105, filed on Mar. 27, 2023.

(30) Foreign Application Priority Data
Apr. 27, 2022 (CN) 202210452334.7

(51) Int. Cl. H04B 7/185; H04W 64/00

(52) U.S. Cl. CPC H04B 7/18519; H04W 64/003

(57) ABSTRACT

The technology of this application relates to a communication method and apparatus. In the method, a terminal device camping on a satellite cell receives first information, where the first information includes at least one first reference point and a frequency of at least one neighboring cell corresponding to the first reference point. The first reference point indicates a location in a first area other than a location of a network device to which the at least one neighboring cell corresponding to the first reference point belongs, and the first area includes a coverage area of the at least one neighboring cell corresponding to the first reference point. The terminal device measures the frequency of the at least one neighboring cell corresponding to the first reference point if a location of the terminal device is within a distance range of the first reference point.

### CROSS-REFERENCE TO RELATED APPLICATIONS

This application is a continuation of International Application No. PCT/CN 2023/084105, filed on Mar. 27, 2023, which claims priority to Chinese Patent Application No. 202210452334.7, filed on Apr. 27, 2022. The disclosures of the aforementioned applications are hereby incorporated by reference in their entireties.

### TECHNICAL FIELD

This application relates to the communication field, and in particular, to a communication method and apparatus.

### BACKGROUND

Satellite communication is communication that uses a satellite as a relay. A combination of satellite communication and terrestrial communication is greatly beneficial in terms of wide coverage, reliability, multi-connectivity, and a high throughput.

In a scenario in which the satellite communication and the terrestrial communication coexist, a neighboring cell of a satellite cell includes a ground cell and/or another satellite cell. When the neighboring cell is a ground cell, the neighboring cell may be located within the satellite cell, or may be located at an edge of the satellite cell. Usually, a satellite cell has a larger coverage area than a ground cell. Therefore, a neighboring cell of the satellite cell may include a large quantity of ground cells. If a terminal device camping on a satellite cell measures frequencies of all neighboring cells of the satellite cell, there may be a large quantity of neighboring cells to be measured. Consequently, power consumption of the terminal device is high.

### SUMMARY

Embodiments of this application provide a communication method and apparatus, to reduce power consumption of a terminal device for cell measurement.

According to a first aspect, an embodiment of this application provides a communication method. The method is applied to a terminal device camping on a satellite cell, and the method includes: The terminal device receives first information, where the first information includes at least one first reference point and a frequency of at least one neighboring cell corresponding to the first reference point. The first reference point indicates a location in a first area other than a location of a network device to which the at least one neighboring cell corresponding to the first reference point belongs, and the first area includes a coverage area of the at least one neighboring cell corresponding to the first reference point. The terminal device measures the frequency of the at least one neighboring cell corresponding to the first reference point if a location of the terminal device is within a distance range of the first reference point.

It can be learned that the frequency measured by the terminal device is a frequency of a neighboring cell corresponding to a first reference point that meets a condition, and the first reference point meets the following condition: The location of the terminal device is within a distance range of the first reference point. Compared with a manner in which the terminal device measures received frequencies of all neighboring cells, this manner reduces power consumption and overheads of the terminal device for cell measurement. In addition, in the method, the location indicated by the first reference point in the first information is not the location of the network device to which the neighboring cell belongs. It can be learned that the first information does not expose the location of the network device to which the neighboring cell belongs, to avoid introducing a security problem.

In an optional implementation, that the terminal device measures the frequency of the at least one neighboring cell corresponding to the first reference point if the location of the terminal device is within the distance range of the first reference point includes: The terminal device measures a first frequency if a distance between the location of the terminal device and the first reference point is less than or equal to a first threshold corresponding to the first frequency, where the first frequency is a frequency in the frequency of the at least one neighboring cell corresponding to the first reference point. It can be learned that the terminal device may compare the distance between the location of the terminal device and the first reference point with a threshold corresponding to a frequency corresponding to the first reference point, to determine whether the location of the terminal device is within the distance range of the first reference point, and further determine whether to measure the frequency.

Optionally, the first reference point corresponds to one frequency, and the frequency corresponds to one first threshold.

Optionally, the first reference point corresponds to a plurality of frequencies. The plurality of frequencies correspond to a same first threshold, or the plurality of frequencies correspond to at least two different first thresholds.

In an optional implementation, the method further includes: The terminal device receives second information, where the second information includes a second reference point. That the terminal device measures the frequency of the at least one neighboring cell corresponding to the first reference point if the location of the terminal device is within the distance range of the first reference point includes: The terminal device measures the frequency of the at least one neighboring cell corresponding to the first reference point if the location of the terminal device is within the distance range of the first reference point, and a distance between the location of the terminal device and the second reference point is greater than or equal to a second threshold.

In an optional implementation, the method further includes: The terminal device receives third information, where the third information includes an opening angle that uses a third reference point as a vertex and uses a reference direction as an angular bisector. That the terminal device measures the frequency of the at least one neighboring cell corresponding to the first reference point if the location of the terminal device is within the distance range of the first reference point includes: The terminal device measures the frequency of the at least one neighboring cell corresponding to the first reference point if the location of the terminal device is within the distance range of the first reference point, and is within a sector area corresponding to the opening angle.

This manner is applicable to a case in which when neighboring cells are distributed in a sector area of an opening angle in a centralized manner, the terminal device located within the sector area of the opening angle measures the frequency of the neighboring cell corresponding to the first reference point when the location of the terminal device is within the distance range of the first reference point. However, a terminal device located outside the sector area of the opening angle may not perform cell measurement on the frequency of the neighboring cell in the first information, to reduce power consumption and overheads of the terminal device located outside the sector area of the opening angle.

In an optional implementation, the at least one neighboring cell corresponding to the first reference point is a cell corresponding to a first beam in a neighboring cell of the satellite cell, and the first beam is a beam corresponding to receiving the first information by the terminal device. It can be learned that a frequency that the terminal device may need to measure is a frequency of the cell corresponding to the first beam, and a frequency of a cell corresponding to another beam in the satellite cell does not need to be measured. Compared with a manner in which the terminal device measures frequencies of all neighboring cells of the satellite cell, this manner can reduce power consumption and overheads of the terminal device for cell measurement.

In an optional implementation, the at least one neighboring cell corresponding to the first reference point is a first neighboring cell or a second neighboring cell. If the neighboring cell to be measured by the terminal device includes the first neighboring cell and the second neighboring cell, that the terminal device measures the frequency of the at least one neighboring cell corresponding to the first reference point includes: The terminal device measures a frequency of the first neighboring cell, where a priority of the first neighboring cell is higher than a priority of the second neighboring cell. If a measurement result meets an access requirement, the terminal device accesses the first neighboring cell; or if a measurement result does not meet an access requirement, the terminal device measures a frequency of the second neighboring cell. It can be learned that the terminal device may first measure a frequency of a neighboring cell with a high priority. When a measurement result meets an access requirement, the terminal device does not need to measure a frequency of a neighboring cell with a low priority, and does not need to measure to-be-measured frequencies of all neighboring cells, so that power consumption and overheads of the terminal device can be reduced.

Optionally, the first neighboring cell is a ground cell in the neighboring cell of the satellite cell, and the second neighboring cell is a satellite cell in the neighboring cell of the satellite cell.

According to a second aspect, an embodiment of this application provides a communication method. The method is applied to a network device to which a satellite cell belongs, and the method includes: The network device sends first information, where the first information includes at least one first reference point and a frequency of at least one neighboring cell corresponding to the first reference point; and the first reference point indicates a location in a first area other than a location of the network device to which the at least one neighboring cell corresponding to the first reference point belongs, and the first area includes a coverage area of the at least one neighboring cell corresponding to the first reference point.

It can be learned that the network device sends the at least one first reference point and the frequency of the neighboring cell corresponding to the first reference point. This manner helps measure the frequency of the neighboring cell corresponding to the first reference point when a location of a terminal device is within a distance range of the first reference point, without directly measuring all frequencies sent by the network device. This helps reduce power consumption and overheads of the terminal device for cell measurement. In addition, the location indicated by the first reference point in the first information is not the location of the network device to which the neighboring cell belongs. It can be learned that the first information does not expose the location of the network device to which the neighboring cell belongs to avoid introducing a security problem.

In an optional implementation, the method further includes: The network device sends second information, where the second information includes a second reference point. This manner helps the terminal device determine a to-be-measured frequency with reference to the first reference point and the second reference point.

In an optional implementation, the method further includes: The network device sends third information, where the third information includes an opening angle that uses a third reference point as a vertex and uses a reference direction as an angular bisector. This manner is applicable to a case in which when neighboring cells are distributed in some directions in a centralized manner, the network device may determine an opening angle based on a distribution status of the neighboring cells, so that the terminal device can further determine a to-be-measured frequency with reference to whether the location of the terminal device is within a sector area corresponding to the opening angle.

In an optional implementation, the at least one neighboring cell corresponding to the first reference point is a cell corresponding to a first beam in a neighboring cell of the satellite cell, and the first beam is a beam used by the network device to send the first information. In this manner, a frequency that the terminal device may need to measure is a frequency of the cell corresponding to the first beam, and a frequency of a cell corresponding to another beam in the satellite cell does not need to be measured. This can reduce power consumption and overheads of the terminal device for cell measurement.

According to a third aspect, an embodiment of this application provides a communication method. The method is applied to a terminal device camping on a satellite cell, and the method includes: The terminal device receives fourth information, where the fourth information includes a frequency of at least one neighboring cell; and the at least one neighboring cell is a cell corresponding to a first beam in a neighboring cell of the satellite cell, and the first beam is a beam corresponding to receiving the fourth information by the terminal device. The terminal device measures the frequency of the at least one neighboring cell.

It can be learned that the fourth information received by the terminal device is beam-level information, a frequency that the terminal device may need to measure is a frequency of the cell corresponding to the first beam in the neighboring cell of the satellite cell, and a frequency of a cell that does not correspond to the first beam in the neighboring cell of the satellite cell does not need to be measured. This can reduce power consumption and overheads of the terminal device for cell measurement.

In an optional implementation, the method further includes: The terminal device receives fifth information, where the fifth information includes at least one first reference point, and the at least one neighboring cell is at least one neighboring cell corresponding to the first reference point. The first reference point indicates a location in a first area other than a location of a network device to which the at least one neighboring cell corresponding to the first reference point belongs, and the first area includes a coverage area of the at least one neighboring cell corresponding to the first reference point. That the terminal device measures the frequency of the at least one neighboring cell includes: The terminal device measures the frequency of the at least one neighboring cell corresponding to the first reference point if a location of the terminal device is within a distance range of the first reference point. It can be learned that the terminal device may further select, from the neighboring cell in the beam-level fourth information, a neighboring cell corresponding to a first reference point that meets a requirement, and perform measurement on the neighboring cell. The terminal device may not perform measurement on a neighboring cell corresponding to a first reference point that does not meet the requirement, so that power consumption and overheads of the terminal device for cell measurement can be further reduced.

In an optional implementation, that the terminal device measures the frequency of the at least one neighboring cell corresponding to the first reference point if the location of the terminal device is within the distance range of the first reference point includes: The terminal device measures a first frequency if a distance between the location of the terminal device and the first reference point is less than or equal to a first threshold corresponding to the first frequency, where the first frequency is a frequency in the frequency of the at least one neighboring cell corresponding to the first reference point. It can be learned that the terminal device may compare the distance between the location of the terminal device and the first reference point with a threshold corresponding to a frequency corresponding to the first reference point, to determine whether the location of the terminal device is within the distance range of the first reference point, and further determine whether to measure the frequency.

Optionally, the first reference point corresponds to one frequency, and the frequency corresponds to one first threshold.

Optionally, the first reference point corresponds to a plurality of frequencies. The plurality of frequencies correspond to a same first threshold, or the plurality of frequencies correspond to at least two different first thresholds.

In an optional implementation, the method further includes: The terminal device receives second information, where the second information includes a second reference point. That the terminal device measures the frequency of the at least one neighboring cell corresponding to the first reference point if the location of the terminal device is within the distance range of the first reference point includes: The terminal device measures the frequency of the at least one neighboring cell corresponding to the first reference point if the location of the terminal device is within the distance range of the first reference point, and a distance between the location of the terminal device and the second reference point is greater than or equal to a second threshold.

In an optional implementation, the method further includes: The terminal device receives third information, where the third information includes an opening angle that uses a third reference point as a vertex and uses a reference direction as an angular bisector. That the terminal device measures the frequency of the at least one neighboring cell corresponding to the first reference point if the location of the terminal device is within the distance range of the first reference point includes: The terminal device measures the frequency of the at least one neighboring cell corresponding to the first reference point if the location of the terminal device is within the distance range of the first reference point, and is within a sector area corresponding to the opening angle.

This manner is applicable to a case in which when neighboring cells are distributed in a sector area of an opening angle in a centralized manner, the terminal device located within the sector area of the opening angle measures the frequency of the neighboring cell corresponding to the first reference point when the location of the terminal device is within the distance range of the first reference point. However, a terminal device located outside the sector area of the opening angle may not perform cell measurement on the frequency of the neighboring cell in the fourth information, so that power consumption and overheads of the terminal device for cell measurement can be further reduced.

In an optional implementation, if the neighboring cell to be measured by the terminal device includes a first neighboring cell and a second neighboring cell, that the terminal device measures the frequency of the at least one neighboring cell includes: The terminal device measures a frequency of the first neighboring cell, where a priority of the first neighboring cell is higher than a priority of the second neighboring cell. If a measurement result meets an access requirement, the terminal device accesses the first neighboring cell; or if a measurement result does not meet an access requirement, the terminal device measures a frequency of the second neighboring cell. It can be learned that the terminal device may first measure a frequency of a neighboring cell with a high priority. When a measurement result meets an access requirement, the terminal device does not need to measure a frequency of a neighboring cell with a low priority, and does not need to measure to-be-measured frequencies of all neighboring cells, so that power consumption and overheads of the terminal device can be reduced.

Optionally, the first neighboring cell is a ground cell in the neighboring cell of the satellite cell, and the second neighboring cell is a satellite cell in the neighboring cell of the satellite cell.

According to a fourth aspect, an embodiment of this application provides a communication method. The method is applied to a network device to which a satellite cell belongs, and the method includes: The network device sends fourth information, where the fourth information includes a frequency of at least one neighboring cell; and the at least one neighboring cell is a cell corresponding to a first beam in a neighboring cell of the satellite cell, and the first beam is a beam used by the network device to send the fourth information.

It can be learned that the fourth information sent by the network device is beam-level information, a frequency that a terminal device may need to measure is a frequency of the cell corresponding to the first beam in the neighboring cell of the satellite cell, and a frequency of a cell that does not correspond to the first beam in the neighboring cell of the satellite cell does not need to be measured. This helps reduce power consumption and overheads of the terminal device for cell measurement.

In an optional implementation, the method further includes: The network device sends fifth information, where the fifth information includes at least one first reference point, and the at least one neighboring cell is at least one neighboring cell corresponding to the first reference point. The first reference point indicates a location in a first area other than a location of the network device to which the at least one neighboring cell corresponding to the first reference point belongs, and the first area includes a coverage area of the at least one neighboring cell corresponding to the first reference point. It can be learned that, this manner helps measure the frequency of the neighboring cell corresponding to the first reference point when a location of the terminal device is within a distance range of the first reference point, without directly measuring all frequencies in the fourth information. This helps reduce power consumption and overheads of the terminal device for cell measurement.

In an optional implementation, the method further includes: The network device sends second information, where the second information includes a second reference point.

In an optional implementation, the method further includes: The network device sends third information, where the third information includes an opening angle that uses a third reference point as a vertex and uses a reference direction as an angular bisector. This manner is applicable to a case in which when neighboring cells are distributed in some directions in a centralized manner, the network device may determine an opening angle based on a distribution status of the neighboring cells, so that the terminal device can further determine a to-be-measured frequency with reference to whether the location of the terminal device is within a sector area corresponding to the opening angle.

According to a fifth aspect, an embodiment of this application provides a communication method. The method is applied to a terminal device camping on a satellite cell, and the method includes: The terminal device receives sixth information, where the sixth information includes an opening angle that uses a third reference point as a vertex and uses a reference direction as an angular bisector, and a frequency of at least one neighboring cell; and the at least one neighboring cell is a ground cell in a neighboring cell of the satellite cell. The terminal device measures the frequency of the at least one neighboring cell if a location of the terminal device is within a sector area corresponding to the opening angle, and a movement direction of the terminal device is an orientation of the opening angle, or a location of the terminal device is within a sector area corresponding to the opening angle, and a distance between the terminal device and the third reference point is greater than a third threshold.

This manner is applicable to a case in which when neighboring cells are distributed in a sector area of an opening angle in a centralized manner, the terminal device measures the frequency of the at least one neighboring cell in the sixth information when the foregoing requirement is met. Compared with a manner in which the terminal device measures frequencies of all neighboring cells of the satellite cell, this manner can reduce power consumption and overheads of the terminal device for cell measurement.

Optionally, the at least one neighboring cell is a ground cell corresponding to a first beam in the neighboring cell of the satellite cell, and the first beam is a beam corresponding to receiving the sixth information by the terminal device. It can be learned that the sixth information may be beam-level information, and the terminal device does not need to measure a frequency of a ground cell that does not correspond to the first beam in the neighboring cell of the satellite cell. This can reduce power consumption and overheads of the terminal device.

In an optional implementation, the method further includes: The terminal device receives fifth information, where the fifth information includes at least one first reference point, and the at least one neighboring cell is at least one neighboring cell corresponding to the first reference point. The first reference point indicates a location in a first area other than a location of a network device to which the at least one neighboring cell corresponding to the first reference point belongs, and the first area includes a coverage area of the at least one neighboring cell corresponding to the first reference point. That the terminal device measures the frequency of the at least one neighboring cell includes: The terminal device measures the frequency of the at least one neighboring cell corresponding to the first reference point if the location of the terminal device is within a distance range of the first reference point.

It can be learned that if the location of the terminal device is within the sector area corresponding to the opening angle, and the movement direction of the terminal device is the orientation of the opening angle, or the location of the terminal device is within the sector area corresponding to the opening angle, and the distance between the terminal device and the third reference point is greater than the third threshold, the terminal device may further select, from the neighboring cell in the sixth information, a neighboring cell corresponding to a first reference point that meets a requirement, and perform measurement on the neighboring cell. The terminal device may not perform measurement on a neighboring cell corresponding to a first reference point that does not meet the requirement, so that power consumption and overheads of the terminal device for cell measurement can be further reduced.

In an optional implementation, that the terminal device measures the frequency of the at least one neighboring cell corresponding to the first reference point if the location of the terminal device is within the distance range of the first reference point includes: The terminal device measures a first frequency if a distance between the location of the terminal device and the first reference point is less than or equal to a first threshold corresponding to the first frequency, where the first frequency is a frequency in the frequency of the at least one neighboring cell corresponding to the first reference point. It can be learned that the terminal device may compare the distance between the location of the terminal device and the first reference point with a threshold corresponding to a frequency corresponding to the first reference point, to determine whether the location of the terminal device is within the distance range of the first reference point, and further determine whether to measure the frequency.

Optionally, the first reference point corresponds to one frequency, and the frequency corresponds to one first threshold.

Optionally, the first reference point corresponds to a plurality of frequencies. The plurality of frequencies correspond to a same first threshold, or the plurality of frequencies correspond to at least two different first thresholds.

In an optional implementation, the method further includes: The terminal device receives second information, where the second information includes a second reference point. That the terminal device measures the frequency of the at least one neighboring cell corresponding to the first reference point if the location of the terminal device is within the distance range of the first reference point includes: The terminal device measures the frequency of the at least one neighboring cell corresponding to the first reference point if the location of the terminal device is within the distance range of the first reference point, and a distance between the location of the terminal device and the second reference point is greater than or equal to a second threshold.

In an optional implementation, if the neighboring cell to be measured by the terminal device includes a first neighboring cell and a second neighboring cell, that the terminal device measures the frequency of the at least one neighboring cell includes: The terminal device measures a frequency of the first neighboring cell, where a priority of the first neighboring cell is higher than a priority of the second neighboring cell. If a measurement result meets an access requirement, the terminal device accesses the first neighboring cell; or if a measurement result does not meet an access requirement, the terminal device measures a frequency of the second neighboring cell. It can be learned that the terminal device may first measure a frequency of a neighboring cell with a high priority. When a measurement result meets an access requirement, the terminal device does not need to measure a frequency of a neighboring cell with a low priority, and does not need to measure to-be-measured frequencies of all neighboring cells, so that power consumption and overheads of the terminal device can be reduced.

Optionally, the first neighboring cell is a ground cell in the neighboring cell of the satellite cell, and the second neighboring cell is a satellite cell in the neighboring cell of the satellite cell.

According to a sixth aspect, an embodiment of this application provides a communication method. The method is applied to a network device to which a satellite cell belongs, and the method includes: The network device sends sixth information, where the sixth information includes an opening angle that uses a third reference point as a vertex and uses a reference direction as an angular bisector, and a frequency of at least one neighboring cell; and the at least one neighboring cell is a ground cell in a neighboring cell of the satellite cell.

This manner is applicable to a case in which when ground cells in neighboring cells of the satellite cell are distributed in a sector area of an opening angle in a centralized manner, the network device sends the opening angle to a terminal device to notify the terminal device of a distribution status of the neighboring cells, so that the terminal device can determine, based on the sector area corresponding to the opening angle, whether to measure the ground cell in the sixth information. Compared with a manner in which all terminal devices camping on the satellite cell need to measure a frequency of the ground cell in the neighboring cell of the satellite cell, this manner can reduce power consumption and overheads of the terminal device for cell measurement.

Optionally, the at least one neighboring cell is a ground cell corresponding to a first beam in the neighboring cell of the satellite cell, and the first beam is a beam used by the network device to send the sixth information. In this manner, a frequency that the terminal device may need to measure is a frequency of the ground cell corresponding to the first beam, and a frequency of a ground cell corresponding to another beam in the satellite cell does not need to be measured. This can reduce power consumption and overheads of the terminal device for cell measurement.

In an optional implementation, the method further includes: The network device sends fifth information, where the fifth information includes at least one first reference point, and the at least one neighboring cell is at least one neighboring cell corresponding to the first reference point. The first reference point indicates a location in a first area other than a location of the network device to which the at least one neighboring cell corresponding to the first reference point belongs, and the first area includes a coverage area of the at least one neighboring cell corresponding to the first reference point. It can be learned that, this manner helps the terminal device determine a to-be-measured frequency with reference to the opening angle in the sixth information and the first reference point in the fifth information. This helps reduce power consumption and overheads of the terminal device for cell measurement.

In an optional implementation, the method further includes: The network device sends second information, where the second information includes a second reference point. It can be learned that, this manner helps the terminal device determine a to-be-measured frequency with reference to the opening angle in the sixth information and the second reference point in the fifth information. This helps reduce power consumption and overheads of the terminal device for cell measurement.

According to a seventh aspect, this application further provides a communication apparatus. The communication apparatus has a function of implementing some or all of the function implementations in any one of the first aspect to the sixth aspect. The function may be implemented by hardware, or may be implemented by hardware executing corresponding software. The hardware or the software includes at least one unit or module corresponding to the foregoing function.

In a possible implementation, a structure of the communication apparatus may include a processing unit and a communication unit. The processing unit is configured to support the communication apparatus in performing a corresponding function in the foregoing method. The communication unit is configured to support communication between the communication apparatus and another communication apparatus. The communication apparatus may further include a storage unit. The storage unit is configured to be coupled to the processing unit and the communication unit, and stores program instructions and data that are necessary for the communication apparatus. Optionally, the processing unit may be configured to control the communication unit to receive and send data/signaling.

In an implementation, the communication unit is configured to receive first information, where the first information includes at least one first reference point and a frequency of at least one neighboring cell corresponding to the first reference point. The first reference point indicates a location in a first area other than a location of a network device to which the at least one neighboring cell corresponding to the first reference point belongs, and the first area includes a coverage area of the at least one neighboring cell corresponding to the first reference point. The processing unit is configured to measure the frequency of the at least one neighboring cell corresponding to the first reference point if a location of the communication apparatus is within a distance range of the first reference point.

In addition, for another optional implementation of the communication apparatus in this aspect, refer to related content of the first aspect.

In another implementation, the communication unit is configured to send first information, where the first information includes at least one first reference point and a frequency of at least one neighboring cell corresponding to the first reference point; and the first reference point indicates a location in a first area other than a location of a network device to which the at least one neighboring cell corresponding to the first reference point belongs, and the first area includes a coverage area of the at least one neighboring cell corresponding to the first reference point.

In addition, for another optional implementation of the communication apparatus in this aspect, refer to related content of the second aspect.

In another implementation, the communication unit is configured to receive fourth information, where the fourth information includes a frequency of at least one neighboring cell; and the at least one neighboring cell is a cell corresponding to a first beam in a neighboring cell of a satellite cell, and the first beam is a beam corresponding to receiving the fourth information by the communication unit. The processing unit is configured to measure the frequency of the at least one neighboring cell.

In addition, for another optional implementation of the communication apparatus in this aspect, refer to related content of the third aspect.

In another implementation, the communication unit is configured to send fourth information, where the fourth information includes a frequency of at least one neighboring cell; and the at least one neighboring cell is a cell corresponding to a first beam in a neighboring cell of a satellite cell, and the first beam is a beam used by the network device to send the fourth information.

In addition, for another optional implementation of the communication apparatus in this aspect, refer to related content of the fourth aspect.

In another implementation, the communication unit is configured to receive sixth information, where the sixth information includes an opening angle that uses a third reference point as a vertex and uses a reference direction as an angular bisector, and a frequency of at least one neighboring cell; and the at least one neighboring cell is a ground cell in a neighboring cell of a satellite cell. The processing unit is configured to measure the frequency of the at least one neighboring cell if a location of the communication apparatus is within a sector area corresponding to the opening angle, and a movement direction of the communication apparatus is an orientation of the opening angle, or if a location of the communication apparatus is within a sector area corresponding to the opening angle, and a distance between the communication apparatus and the third reference point is greater than a third threshold.

In addition, for another optional implementation of the communication apparatus in this aspect, refer to related content of the fifth aspect.

In another implementation, the communication unit is configured to send sixth information, where the sixth information includes an opening angle that uses a third reference point as a vertex and uses a reference direction as an angular bisector, and a frequency of at least one neighboring cell; and the at least one neighboring cell is a ground cell in a neighboring cell of a satellite cell.

In addition, for another optional implementation of the communication apparatus in this aspect, refer to related content of the sixth aspect.

For example, the communication unit may be an input/output interface, the storage unit may be a memory, and the processing unit may be a processor.

In an implementation, the communication apparatus includes the processor and the input/output interface. The input/output interface is configured to receive first information, where the first information includes at least one first reference point and a frequency of at least one neighboring cell corresponding to the first reference point. The first reference point indicates a location in a first area other than a location of a network device to which the at least one neighboring cell corresponding to the first reference point belongs, and the first area includes a coverage area of the at least one neighboring cell corresponding to the first reference point. The processor is configured to measure the frequency of the at least one neighboring cell corresponding to the first reference point if a location of the communication apparatus is within a distance range of the first reference point.

In addition, for another optional implementation of the communication apparatus in this aspect, refer to related content of the first aspect.

In another implementation, the communication apparatus includes the input/output interface. The input/output interface is configured to send first information, where the first information includes at least one first reference point and a frequency of at least one neighboring cell corresponding to the first reference point; and the first reference point indicates a location in a first area other than a location of a network device to which the at least one neighboring cell corresponding to the first reference point belongs, and the first area includes a coverage area of the at least one neighboring cell corresponding to the first reference point.

In addition, for another optional implementation of the communication apparatus in this aspect, refer to related content of the second aspect.

In another implementation, the communication apparatus includes the processor and the input/output interface. The input/output interface is configured to receive fourth information, where the fourth information includes a frequency of at least one neighboring cell; and the at least one neighboring cell is a cell corresponding to a first beam in a neighboring cell of a satellite cell, and the first beam is a beam corresponding to receiving the fourth information by the communication unit. The processor is configured to measure the frequency of the at least one neighboring cell.

In addition, for another optional implementation of the communication apparatus in this aspect, refer to related content of the third aspect.

In another implementation, the communication apparatus includes the input/output interface. The input/output interface is configured to send fourth information, where the fourth information includes a frequency of at least one neighboring cell; and the at least one neighboring cell is a cell corresponding to a first beam in a neighboring cell of a satellite cell, and the first beam is a beam used by the network device to send the fourth information.

In addition, for another optional implementation of the communication apparatus in this aspect, refer to related content of the fourth aspect.

In another implementation, the communication apparatus includes the processor and the input/output interface. The input/output interface is configured to receive sixth information, where the sixth information includes an opening angle that uses a third reference point as a vertex and uses a reference direction as an angular bisector, and a frequency of at least one neighboring cell; and the at least one neighboring cell is a ground cell in a neighboring cell of a satellite cell. The processor is configured to measure the frequency of the at least one neighboring cell if a location of the communication apparatus is within a sector area corresponding to the opening angle, and a movement direction of the communication apparatus is an orientation of the opening angle, or if a location of the communication apparatus is within a sector area corresponding to the opening angle, and a distance between the communication apparatus and the third reference point is greater than a third threshold.

In addition, for another optional implementation of the communication apparatus in this aspect, refer to related content of the fifth aspect.

In another implementation, the communication apparatus includes the input/output interface. The input/output interface sends sixth information, where the sixth information includes an opening angle that uses a third reference point as a vertex and uses a reference direction as an angular bisector, and a frequency of at least one neighboring cell; and the at least one neighboring cell is a ground cell in a neighboring cell of a satellite cell.

In addition, for another optional implementation of the communication apparatus in this aspect, refer to related content of the sixth aspect.

In another possible implementation, the communication apparatus is a chip or a chip system. The processing unit may also be represented as a processing circuit or a logic circuit. The transceiver unit may be an input/output interface, an interface circuit, an output circuit, an input circuit, a pin, a related circuit, or the like on the chip or the chip system.

In an implementation process, the processor may be configured to perform, for example, but not limited to, baseband-related processing; and the input/output interface may be configured to perform, for example, but not limited to, radio frequency receiving and sending. The foregoing components may be separately disposed on chips that are independent of each other, or at least some or all of the components may be disposed on a same chip. For example, the processor may be further divided into an analog baseband processor and a digital baseband processor. The analog baseband processor and the input/output interface may be integrated on a same chip, and the digital baseband processor may be disposed on an independent chip. With continuous development of an integrated circuit technology, increasingly more components may be integrated on a same chip. For example, the digital baseband processor and a plurality of application processors (for example, but not limited to, a graphics processing unit and a multimedia processor) may be integrated on a same chip. Such a chip may be referred to as a system-on-a-chip (SoC). Whether the components are separately disposed on different chips or integrated and disposed on one or more chips usually depends on a requirement of a product design. Embodiments of this application impose no limitation on specific implementations of the foregoing components.

According to an eighth aspect, this application further provides a processor, configured to perform the foregoing methods. In a process of performing these methods, a process of sending the foregoing information and a process of receiving the foregoing information in the foregoing methods may be understood as a process of outputting the foregoing information by the processor and a process of receiving the foregoing input information by the processor. When outputting the foregoing information, the processor outputs the information to an input/output interface, so that the input/output interface transmits the information. After the foregoing information is outputted by the processor, other processing may further need to be performed on the information before the information arrives at the input/output interface. Similarly, when the processor receives the foregoing input information, the input/output interface receives the information, and inputs the information into the processor. Further, after the input/output interface receives the information, other processing may need to be performed on the information before the information is input into the processor.

Operations such as sending and receiving related to the processor may be more generally understood as operations such as output, receiving, and input of the processor, unless otherwise specified, or if the operations do not conflict with actual functions or internal logic of the operations in related descriptions.

In an implementation process, the processor may be a processor specially configured to perform these methods, or a processor, for example, a general-purpose processor, that performs these methods by executing computer instructions in a memory. The memory may be a non-transitory (non-transitory) memory, for example, a read-only memory (Read-Only Memory, ROM). The memory and the processor may be integrated on a same chip, or may be separately disposed on different chips. A type of the memory and a manner of disposing the memory and the processor are not limited in embodiments of this application.

According to a ninth aspect, this application further provides a communication system. The system includes at least one terminal device and at least one network device in the foregoing aspects. In another possible implementation, the system may further include another device that is in the solutions provided in this application and that interacts with the terminal device and the network device.

According to a tenth aspect, this application provides a computer-readable storage medium, configured to store instructions. When the instructions are run by a computer, the method according to any one of the first aspect, the second aspect, the third aspect, the fourth aspect, the fifth aspect, or the sixth aspect is implemented.

According to an eleventh aspect, this application further provides a computer program product including instructions. When the computer program product runs on a computer, the method according to any one of the first aspect, the second aspect, the third aspect, the fourth aspect, the fifth aspect, or the sixth aspect is implemented.

According to a twelfth aspect, this application provides a chip system. The chip system includes a processor and an interface, the interface is configured to obtain a program or instructions, and the processor is configured to invoke the program or the instructions to implement a function in the first aspect, the second aspect, the third aspect, the fourth aspect, the fifth aspect, or the sixth aspect. In a possible implementation, the chip system further includes a memory. The memory is configured to store program instructions and data that are necessary for a terminal. The chip system may include a chip, or may include a chip and another discrete component.

### BRIEF DESCRIPTION OF DRAWINGS

FIG. 1 is a diagram of a system architecture of a satellite-terrestrial integrated network according to an example embodiment of this application;

FIG. 2 is a diagram of a structure of a communication system according to an example embodiment of this application;

FIG. 3 is a diagram of interaction of a communication method 100 according to an example embodiment of this application;

FIG. 4 is a diagram of distribution of neighboring cells of a satellite cell according to an example embodiment of this application;

FIG. 5 is another diagram of distribution of neighboring cells of a satellite cell according to an example embodiment of this application;

FIG. 6 is another diagram of distribution of neighboring cells of a satellite cell according to an example embodiment of this application;

FIG. 7 is another diagram of distribution of neighboring cells of a satellite cell according to an example embodiment of this application;

FIG. 8 is another diagram of distribution of neighboring cells of a satellite cell according to an example embodiment of this application;

FIG. 9 is a diagram of interaction of a communication method 200 according to an example embodiment of this application;

FIG. 10 is a diagram of interaction of a communication method 300 according to an example embodiment of this application;

FIG. 11 is another diagram of distribution of neighboring cells of a satellite cell according to an example embodiment of this application;

FIG. 12 is another diagram of distribution of neighboring cells of a satellite cell according to an example embodiment of this application;

FIG. 13 is another diagram of distribution of neighboring cells of a satellite cell according to an example embodiment of this application;

FIG. 14 is a diagram of a structure of a communication apparatus according to an example embodiment of this application;

FIG. 15 is a diagram of a structure of another communication apparatus according to an example embodiment of this application; and

FIG. 16 is a diagram of a structure of a chip according to an example embodiment of this application.

### DESCRIPTION OF EMBODIMENTS

The following clearly and completely describes the technical solutions in embodiments of this application with reference to the accompanying drawings in embodiments of this application.

To better understand a communication method disclosed in embodiments of this application, a communication system to which embodiments of this application are applicable is described.

Embodiments of this application may be applied to a fourth generation (4G) communication system, for example, a long term evolution (LTE) system, and a fifth generation (5G) communication system, for example, a new radio (NR) system. With continuous development of communication technologies, the technical solutions in embodiments of this application may be further applied to a subsequently evolved communication system, for example, a sixth generation (6G) mobile communication technology system and a seventh generation (7G) mobile communication technology system.

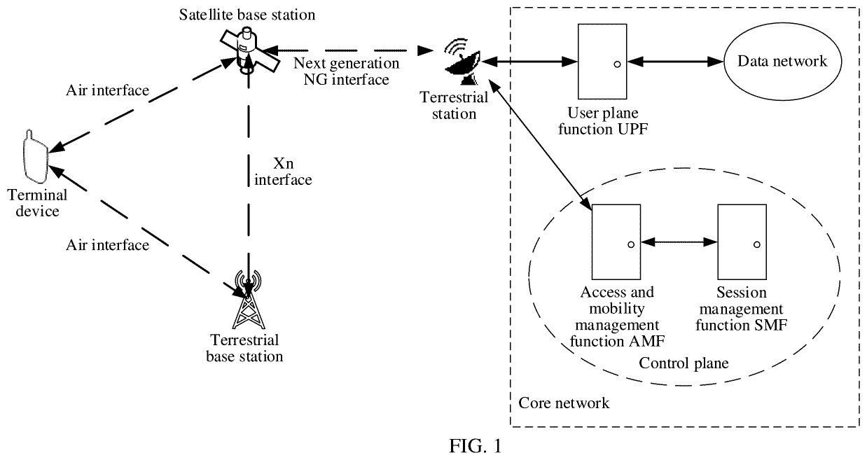

FIG. 1 is a diagram of a system architecture of a satellite-terrestrial integrated network according to an embodiment of this application. The system architecture may include a terminal device, a satellite base station, a terrestrial station, a terrestrial base station, and a core network. The terminal device may separately communicate with the satellite base station and the terrestrial base station through an air interface. In other words, the terminal device may access a satellite cell or a ground cell. The satellite base station may exchange signaling and user service data with the terrestrial station through a next generation (NG) interface. Both the terrestrial station and the terrestrial base station may be connected to the core network through a wired link or a wireless link. The terrestrial station and the terrestrial base station may be connected to a same core network or different core networks. In addition, signaling exchange and user data transmission may be further performed between the satellite base station and the terrestrial base station through an Xn interface. For example, signaling exchanged between the satellite base station and the terrestrial base station may be signaling used for handover between the satellite base station and the terrestrial base station.

In embodiments of this application, a scenario in which a satellite cell formed by coverage of a satellite coexists with a ground cell formed by coverage of a terrestrial base station is used as an example. However, the solutions are also applicable to another scenario in which a cell with a large coverage area coexists with a cell with a small coverage area. The coverage areas herein are relative to the two cells. The terminal device can receive a stronger signal from a cell with a small coverage area than from a cell with a large coverage area. For example, in a scenario in which a cell formed by coverage of a space-based platform coexists with a cell formed by coverage of a terrestrial base station, a coverage area of the cell formed by the coverage of the space-based platform is larger than a coverage area of the cell formed by the coverage of the terrestrial base station because the space-based platform is far away from the ground. For another example, in a scenario in which a cell formed by coverage of a terrestrial base station coexists with a cell formed by coverage of an uncrewed aerial vehicle, a coverage area of the cell formed by the coverage of the terrestrial base station is larger than a coverage area of the cell formed by the coverage of the uncrewed aerial vehicle. This is not limited in this application.

In embodiments of this application, the terminal device may access a satellite network through an air interface, and initiate a service, for example, a call service or an internet access service. The terminal device may be a handheld device, a vehicle-mounted device, a wearable device, a computing device, or the like. For example, the terminal device may be a mobile phone, a tablet computer, a computer having a wireless transceiver function, a virtual reality (VR) terminal device, an augmented reality (AR) terminal device, a wireless terminal in industrial control, a wireless terminal in self-driving, a wireless terminal in telemedicine (e.g., remote medical), a wireless terminal in a smart grid, a wireless terminal in transportation safety, a wireless terminal in a smart city, a wireless terminal in a smart home, or a terminal device in a post-5G evolved communication network. This is not limited in this application.

The satellite base station may be a base station that performs wireless communication based on an artificial earth satellite. The satellite base station may be configured to provide a radio access service for the terminal device, and schedule a radio resource to an accessing terminal device, and may be further configured to provide a reliable radio transmission protocol, a data encryption protocol, and the like. In addition, the satellite base station may be deployed on a satellite, or some functions of the satellite base station may be deployed on the satellite. Alternatively, the satellite base station may be deployed on the ground. In this case, a satellite corresponding to the satellite base station has a transparent transmission and forwarding function. Alternatively, the satellite base station may be directly deployed on a terrestrial station communicating with a satellite.

The terrestrial station is usually a ground device that is disposed on the surface of the earth (including being disposed on a ship or an airplane) to perform satellite communication. The terrestrial station may be configured to forward signaling and service data exchanged between the satellite base station and the core network.

The terrestrial base station is a base station that is deployed on the ground and that directly or indirectly communicates with the terminal device.

The core network may be used to provide services such as user access control, mobility management, session management, user authentication, and accounting. The core network includes a plurality of functional units. The plurality of functional units include a control plane functional entity and a data plane functional entity. The control plane functional entity may include an access and mobility management function (AMF) unit, a session management function (SMF) unit, and the like. The user plane functional entity may include a user plane function (UPF) unit, a data network (DN), and the like. The AMF unit may be configured to be responsible for user access management, authentication, mobility management, and the like. The SMF unit may be configured to manage a session in a mobile network, for example, session establishment, modification, and release. The UPF unit may be configured to manage user plane data transmission, traffic statistics collection, and the like. The UPM unit may be further configured to exchange user plane data with the DN. The DN may be used to provide a data transmission service for the terminal device. The DN may be a public data network (PDN), for example, the internet, or may be a local access data network (LADN), for example, a network of a mobile edge computing (MEC) node.

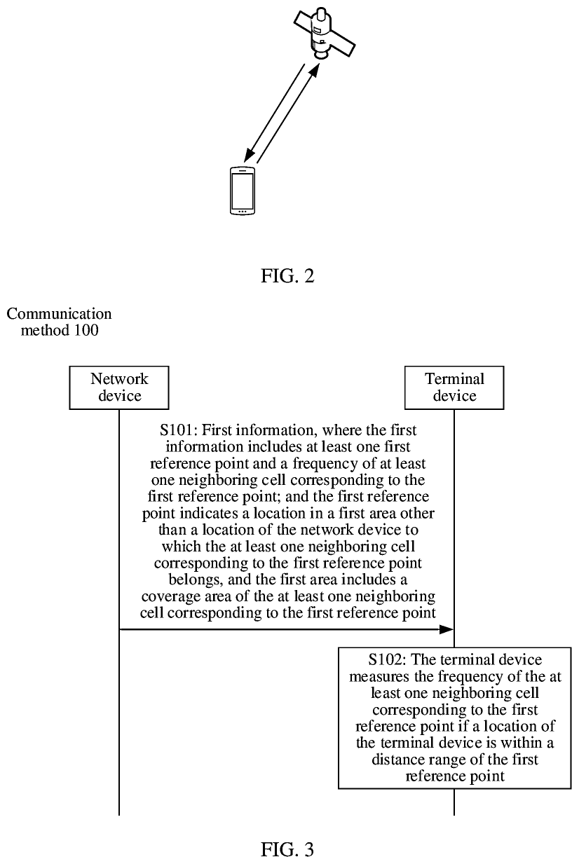

FIG. 2 is a diagram of a structure of a communication system according to an embodiment of this application. The communication system may include but is not limited to one terminal device and one network device. Quantities and forms of devices shown in FIG. 2 are used as examples and do not constitute a limitation on embodiments of this application. During actual application, two or more terminal devices and two or more network devices may be included. The communication system shown in FIG. 2 is described by using one network device and one terminal device as an example. In FIG. 2, for example, the network device is a satellite base station and the terminal device is a mobile phone.

In embodiments of this application, the network device is a device having a wireless transceiver function, and may be a network device in a non-terrestrial network (NTN) communication system, for example, the satellite base station in FIG. 1, or may be a network device in a terrestrial network (TN) communication system, for example, the terrestrial base station in FIG. 1. Optionally, the network device in embodiments of this application may include base stations in various forms, for example, a macro base station, a micro base station (also referred to as a small cell), a relay station, an access point, and a device for implementing a base station function in a post-5G evolved communication system. This is not specifically limited in embodiments of this application.

Satellite communication is communication that uses a satellite as a relay. The satellite communication can provide a wider coverage area. For example, the satellite communication can provide a communication service for some areas that cannot be covered by the terrestrial network, such as oceans and forests. The satellite communication further has high reliability, and can provide a better communication service for an aircraft, a train, and a user on the aircraft or the train. The satellite communication can further provide more data transmission resources and improve a network rate. In addition, when a satellite base station in the satellite communication is deployed on a satellite, the satellite base station is not vulnerable to a natural disaster or an external force.

In a scenario in which the satellite communication and terrestrial communication coexist, a neighboring cell of a satellite cell includes a ground cell and/or another satellite cell. When the neighboring cell is a ground cell, the neighboring cell may be located within the satellite cell. For example, the satellite cell covers a sea, a terrestrial base station may be deployed on a small island in the sea, and a ground cell corresponding to the terrestrial base station is located within the satellite cell. When the neighboring cell is a ground cell, the neighboring cell may be located at an edge of the satellite cell. For example, in a scenario in which a suburban area is adjacent to a city, the suburban area may be covered by the satellite cell, and the city is covered by the ground cell.

Usually, a satellite cell has a larger coverage area than a ground cell. Therefore, a neighboring cell of the satellite cell may include a large quantity of ground cells. If a terminal device camping on the satellite cell measures frequencies of all neighboring cells of the satellite cell, there may be a large quantity of neighboring cells to be measured. Consequently, power consumption and overheads of the terminal device are high.

Embodiments of this application provide a communication method 100, a communication method 200, and a communication method 300, to reduce power consumption and overheads of a terminal device camping on a satellite cell for cell measurement.

In the communication method 100, a terminal device camping on a satellite cell may receive first information, where the first information includes at least one first reference point and a frequency of at least one neighboring cell corresponding to the first reference point. The first reference point indicates a location in a first area other than a location of a network device to which the at least one neighboring cell corresponding to the first reference point belongs, and the first area includes a coverage area of the at least one neighboring cell corresponding to the first reference point. The terminal device measures the frequency of the at least one neighboring cell corresponding to the first reference point if a location of the terminal device is within a distance range of the first reference point.

In the communication method 200, a terminal device camping on a satellite cell may receive fourth information, where the fourth information includes a frequency of at least one neighboring cell; and the at least one neighboring cell is a cell corresponding to a first beam in a neighboring cell of the satellite cell, and the first beam is a beam corresponding to receiving the fourth information by the terminal device. The terminal device measures the frequency of the at least one neighboring cell.

In the communication method 300, a terminal device camping on a satellite cell may receive sixth information, where the sixth information includes an opening angle that uses a third reference point as a vertex and uses a reference direction as an angular bisector, and a frequency of at least one neighboring cell; and the at least one neighboring cell is a ground cell in a neighboring cell of the satellite cell. The terminal device measures the frequency of the at least one neighboring cell if a location of the terminal device is within a sector area corresponding to the opening angle, and a movement direction of the terminal device is an orientation of the opening angle, or a location of the terminal device is within a sector area corresponding to the opening angle, and a distance between the terminal device and the third reference point is greater than a third threshold.

The following describes the communication methods in embodiments of this application with reference to the accompanying drawings.

FIG. 3 is a diagram of interaction of a communication method 100 according to an embodiment of this application. The communication method 100 is described from a perspective of interaction between a terminal device and a network device. The terminal device is a terminal device camping on a satellite cell, and the network device is a network device to which the satellite cell belongs. The communication method 100 includes the following steps.

S101: The network device sends first information, where the first information includes at least one first reference point and a frequency of at least one neighboring cell corresponding to the first reference point; and the first reference point indicates a location in a first area other than a location of the network device to which the at least one neighboring cell corresponding to the first reference point belongs, and the first area includes a coverage area of the at least one neighboring cell corresponding to the first reference point. Correspondingly, the terminal device receives the first information.

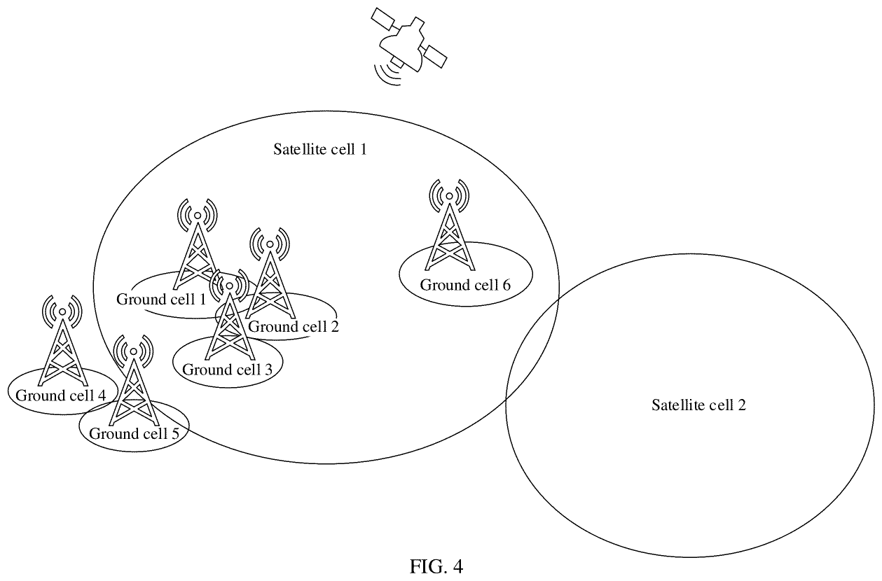

The neighboring cell in step S101 is a neighboring cell of the satellite cell on which the terminal device camps, and the terminal device camping on the satellite cell can receive a signal of the neighboring cell of the satellite cell. The neighboring cell of the satellite cell may be a ground cell, or another satellite cell adjacent to the satellite cell. The ground cell may be located within the satellite cell, or may be located at an edge of the satellite cell. In addition, in neighboring cells of the satellite cell, different neighboring cells may be intra-frequency cells or inter-frequency cells. For example, with reference to FIG. 4, neighboring cells of a satellite cell 1 include a ground cell 1, a ground cell 2, a ground cell 3, a ground cell 4, a ground cell 5, a ground cell 6, and a satellite cell 2. The ground cell 1, the ground cell 2, the ground cell 3, and the ground cell 6 are located within the satellite cell 1, the ground cell 4 and the ground cell 5 are located at an edge of the satellite cell 1, and the satellite cell 2 is adjacent to the satellite cell 1.

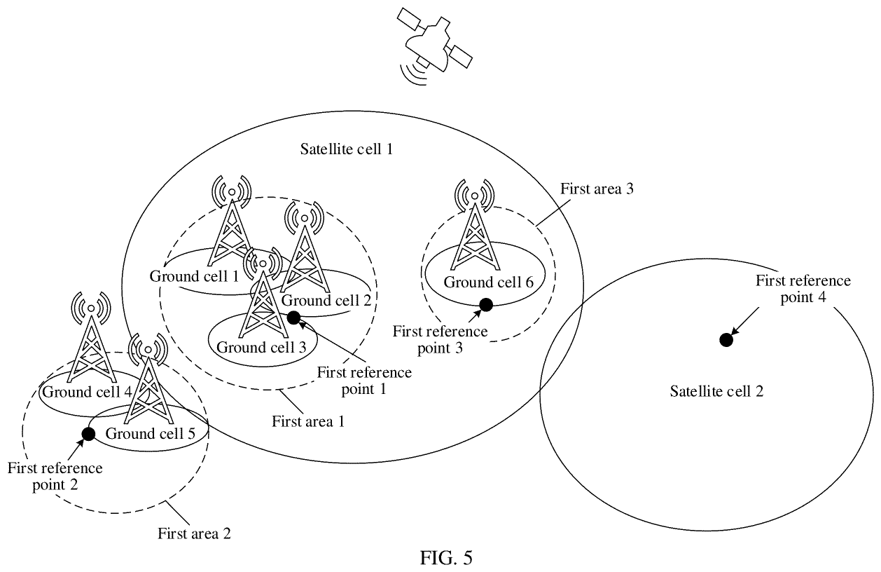

In an optional implementation, in the neighboring cell of the satellite cell, at least one ground cell corresponds to one first reference point, and one satellite cell corresponds to one first reference point. When a plurality of ground cells correspond to one first reference point, the plurality of ground cells may be a plurality of ground cells that are close to each other. In addition, when a satellite base station corresponding to the satellite cell is not deployed on the ground, the location indicated by the first reference point corresponding to the satellite cell may be any location in the satellite cell. A scenario shown in FIG. 4 is used as an example. With reference to FIG. 5, a first reference point 1 corresponds to the ground cell 1, the ground cell 2, and the ground cell 3. In addition, the first reference point 1 indicates a location in a first area 1 other than locations of network devices to which the ground cell 1, the ground cell 2, and the ground cell 3 belong. A first reference point 2 corresponds to the ground cell 4 and the ground cell 5, and the first reference point 2 indicates a location in a first area 2 other than locations of network devices to which the ground cell 4 and the ground cell 5 belong. A first reference point 3 corresponds to the ground cell 6, and the first reference point 3 indicates a location in a first area 3 other than a location of a network device to which the ground cell 6 belongs. A first reference point 4 corresponds to the satellite cell 2, and the first reference point 4 indicates a location in the satellite cell 2.

In an optional implementation, neighboring cells corresponding to all first reference points in the first information include all neighboring cells of the satellite cell on which the terminal device camps. In other words, the first information is cell-level information. A scenario shown in FIG. 5 is used as an example. The first information includes: the first reference point 1 and a frequency of the ground cell 1, a frequency of the ground cell 2, and a frequency of the ground cell 3 that correspond to the first reference point 1; the first reference point 2 and a frequency of the ground cell 4 and a frequency of the ground cell 5 that correspond to the first reference point 2; the first reference point 3 and a frequency of the ground cell 6 that corresponds to the first reference point 3; and the first reference point 4 and a frequency of the satellite cell 2 that corresponds to the first reference point 4.

The following uses an example in which the first reference point 1 to the first reference point 4 are sequentially represented as (x₁, y₁, z₁), (x₂, y₂, z₂), (x₃, y₃, z₃), and (x₃, y₃, z₃), and the frequencies of the ground cell 1 to the ground cell 6 and the frequency of the satellite cell 2 are sequentially represented as f₁, f₂, f₃, f₄, f₅, f₆, and f₇, First information received by a terminal device camping on the satellite cell I may be shown in Table 1.

TABLE 1

| First reference point | Corresponding frequency |
|---|---|
| (x₁, y₁, z₁) | f₁, f₂, and f₃ |
| (x₂, y₂, z₂) | f₄ and f₅ |
| (x₃, y₃, z₃) | f₆ |
| (x₄, y₄, z₄) | f₇ |

In addition, if all the neighboring cells of the satellite cell on which the terminal device camps are satellite cells, in the first information sent by the network device, the neighboring cell corresponding to the first reference point is a satellite cell. If all the neighboring cells of the satellite cell on which the terminal device camps are ground cells, in the first information sent by the network device, the neighboring cell corresponding to the first reference point is a ground cell. If there is no neighboring cell of the satellite cell on which the terminal device camps, the network device may not send the first information. In this case, the terminal device may not perform cell measurement.

In another optional implementation, the at least one neighboring cell corresponding to the first reference point in the first information is a cell corresponding to a first beam in the neighboring cell of the satellite cell, and the first beam is a beam used by the network device to send the first information. In other words, the first information is beam-level information. The cell corresponding to the first beam in the neighboring cell of the satellite cell may be a ground cell located within a coverage area of the first beam, or a ground cell adjacent to the coverage area of the first beam, or may be another satellite cell adjacent to the coverage area of the first beam. In this manner, a frequency that the terminal device may need to measure is a frequency of the cell corresponding to the first beam in the neighboring cell of the satellite cell, and the terminal device may not measure a frequency of a cell that does not correspond to the first beam in the neighboring cell of the satellite cell, so that power consumption and overheads of the terminal device for cell measurement can be reduced.

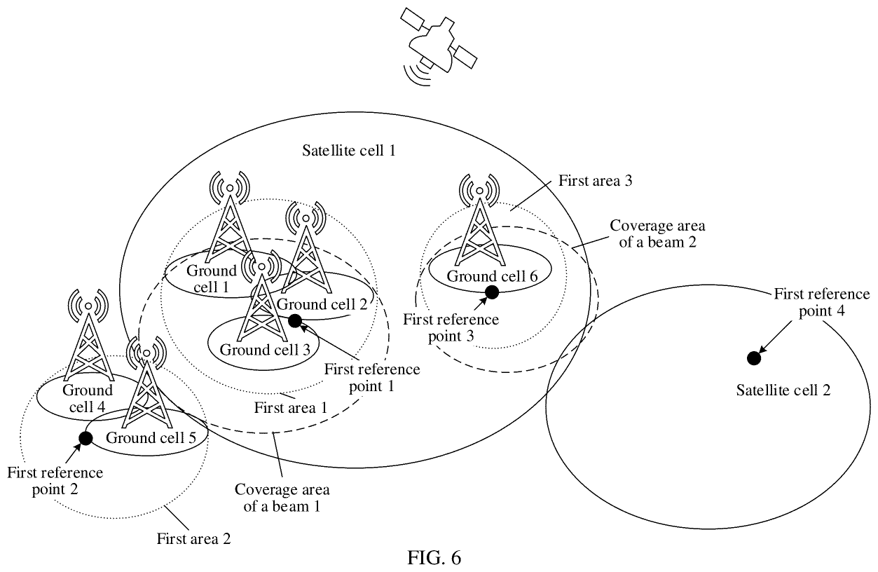

The scenario shown in FIG. 5 is used as an example. With reference to FIG. 6, in the neighboring cells of the satellite cell 1, cells corresponding to a beam 1 include the ground cell 1, the ground cell 2, the ground cell 3, the ground cell 4, and the ground cell 5, and cells corresponding to the beam 2 include the ground cell 6 and the satellite cell 2. In this case, first information received by a terminal device located within a coverage area of the beam 1 includes the first reference point 1 and the frequency of the ground cell 1, the frequency of the ground cell 2, and the frequency of the ground cell 3 that correspond to the first reference point 1; and the first reference point 2 and the frequency of the ground cell 4 and the frequency of the ground cell 5 that correspond to the first reference point 2. First information received by a terminal device located within a coverage area of the beam 2 includes the first reference point 3 and the frequency of the ground cell 6 that corresponds to the first reference point 3; and the first reference point 4 and the frequency of the satellite cell 2 that corresponds to the first reference point 4. The following uses a representation form of each first reference point and a frequency of each cell shown in Table 1 as an example. The first information received by the terminal device located within the coverage area of the beam 1 may be shown in Table 2, and the first information received by the terminal device located within the coverage area of the beam 1 may be shown in Table 3.

TABLE 2

| First reference point | Corresponding frequency |
|---|---|
| (x₁, y₁, z₁) | f₁, f₂, and f₃ |
| (x₂, y₂, z₂) | f₄ and f₅ |

TABLE 3

| First reference point | Corresponding frequency |
|---|---|
| (x₃, y₃, z₃) | f₆ |
| (x₄, y₄, z₄) | f₇ |

Optionally, that the network device sends the first information in step S101 may include: For each of a plurality of beams included in the satellite cell, if there is a cell corresponding to the beam in the neighboring cell of the satellite cell, the network device uses the beam to send first information corresponding to the beam. The first information corresponding to the beam includes at least one first reference point and at least one neighboring cell corresponding to the first reference point, and the at least one neighboring cell corresponding to the first reference point in the first information corresponding to the beam is the cell corresponding to the beam in the neighboring cell of the satellite cell. If there is no cell corresponding to the beam in the neighboring cell of the satellite cell, the network device may not send first information corresponding to the beam. Correspondingly, if a terminal device located within a coverage area of a beam receives first information, it indicates that there is a cell corresponding to the beam in the neighboring cell of the satellite cell. In this case, the terminal device may perform step S102. Alternatively, if a terminal device located within a coverage area of a beam does not receive first information, it indicates that there is no cell corresponding to the beam in the neighboring cell of the satellite cell. In this case, the terminal device may not perform cell measurement. In this manner, power consumption and overheads of the terminal device for cell measurement can be reduced.

S102: The terminal device measures the frequency of the at least one neighboring cell corresponding to the first reference point if a location of the terminal device is within a distance range of the first reference point.

The distance range of the first reference point may be a distance range of a regular shape, for example, a distance range of a circle, an ellipse, or a rectangle. Alternatively, the distance range of the first reference point may be a distance range of an irregular shape.

In addition, in step S102, the terminal device measures the frequency of the at least one neighboring cell corresponding to the first reference point if the location of the terminal device is within the distance range of the first reference point. This operation may further include the following several specific implementations.

Implementation 1: The terminal device measures a first frequency if a distance between the location of the terminal device and the first reference point is less than or equal to a first threshold corresponding to the first frequency, where the first frequency is a frequency in the frequency of the at least one neighboring cell corresponding to the first reference point.

Optionally, the first reference point corresponds to one frequency, and the frequency corresponds to one first threshold. In this case, the first reference point may correspond to one frequency of one neighboring cell, or the first reference point may correspond to one frequency of a plurality of intra-frequency neighboring cells. For example, the first reference point 1 corresponds to the frequency f₁ of the neighboring cell 1, and f₁ corresponds to a first threshold 1. If a distance between the terminal device and the first reference point 1 is less than or equal to the first threshold 1, the terminal device measures f₁. For another example, the neighboring cell 2 and the neighboring cell 3 that correspond to the first reference point 2 are intra-frequency cells, and frequencies of the two cells are both f₂, in other words, the first reference point 2 corresponds to the frequency f₂, and f₂ corresponds to a first threshold 2. If a distance between the terminal device and the first reference point 2 is less than or equal to the first threshold 2, the terminal device measures f₂.

Optionally, the first reference point corresponds to a plurality of frequencies. In this case, the first reference point may correspond to a plurality of frequencies of a plurality of neighboring cells, and there are at least two inter-frequency cells in the plurality of neighboring cells. Optionally, the plurality of frequencies may correspond to a same first threshold. For example, the first reference point 1 corresponds to the frequency f₁ of the neighboring cell 1 and the frequency f₂ of the neighboring cell 2, and both f₁ and f₂ correspond to a first threshold 1. If a distance between the terminal device and the first reference point 1 is less than or equal to the first threshold 1, the terminal device measures f₁ and f₂.

Alternatively, the plurality of frequencies correspond to at least two different first thresholds. For example, the first reference point 2 corresponds to the frequency f₃ of the neighboring cell 3, the frequency f₄ of the neighboring cell 4, and the frequency f₅ of the neighboring cell 5, f₃ and f₃ correspond to a first threshold 2, and f₄ corresponds to a first threshold 3. If a distance between the terminal device and the first reference point 2 is less than or equal to the first threshold 2, the terminal device measures f₃ and f₅. If the distance between the terminal device and the first reference point 2 is less than or equal to the first threshold 3, the terminal device measures f₄.

Optionally, a first threshold corresponding to each of the at least one frequency corresponding to the first reference point may be sent by the network device to the terminal device. Alternatively, a first threshold corresponding to each frequency may be uniformly specified in a protocol. Alternatively, a first threshold corresponding to each frequency may be obtained by the terminal device by querying a predefined table, and the predefined table may be a table representing a correspondence between an index and the first threshold. In this case, the network device may send an index corresponding to each frequency to the terminal device, and the terminal device queries, based on the index corresponding to each frequency, the predefined table for the first threshold corresponding to each frequency. For example, the first reference point corresponds to the frequency f₁ and the frequency f₂, the network device may further send, to the terminal device, an index 1 corresponding to f₁ and an index 2 corresponding to f₂, and the terminal device may obtain the first threshold 1 corresponding to the index 1 and the first threshold 2 corresponding to the index 2 by querying the predefined table. In this way, the terminal device may determine that f₁ corresponds to the first threshold 1 and f₂ corresponds to the first threshold 2.

Implementation 2: If a distance between the location of the terminal device and the first reference point is less than or equal to a fourth threshold corresponding to the first reference point, the terminal device measures the frequency of the at least one neighboring cell corresponding to the first reference point.

Optionally, if the first information includes a plurality of first reference points, the plurality of first reference points may correspond to a same fourth threshold. For example, the plurality of first reference points in the first information include the first reference point 1, the first reference point 2, and the first reference point 3, and all the three first reference points correspond to a fourth threshold 1. For any one of the three first reference points, if a distance between the location of the terminal device and the first reference point is less than or equal to the fourth threshold 1, the terminal device measures a frequency of at least one neighboring cell corresponding to the first reference point.

Alternatively, the plurality of first reference points correspond to at least two different fourth thresholds. For example, the plurality of first reference points in the first information include the first reference point 1, the first reference point 2, and the first reference point 3, both the first reference point 1 and the first reference point 3 correspond to the fourth threshold 1, and the first reference point 2 corresponds to a fourth threshold 2. For the first reference point 1 or the first reference point 3, if a distance between the location of the terminal device and the first reference point is less than or equal to the fourth threshold 1, the terminal device measures a frequency of at least one neighboring cell corresponding to the first reference point. If a distance between the location of the terminal device and the first reference point 2 is less than or equal to the fourth threshold 2, the terminal device measures a frequency of at least one neighboring cell corresponding to the first reference point 2.

Optionally, the fourth threshold corresponding to the first reference point may be sent by the network device to the terminal device. In this case, the network device may determine, based on a size of the first area corresponding to the first reference point, the fourth threshold corresponding to the first reference point. Alternatively, the fourth threshold corresponding to the first reference point may be uniformly specified in a protocol. Alternatively, the fourth threshold corresponding to the first reference point may be obtained by the terminal device by querying a predefined table, and the predefined table may be a table representing a correspondence between an index and the fourth threshold. This case is similar to the manner in which the terminal device determines the first threshold by querying the table in Implementation 1.

Implementation 3: The communication method may further include: The terminal device receives second information, where the second information includes a second reference point. That the terminal device measures the frequency of the at least one neighboring cell corresponding to the first reference point if the location of the terminal device is within the distance range of the first reference point in step S102 may include: The terminal device measures the frequency of the at least one neighboring cell corresponding to the first reference point if the location of the terminal device is within the distance range of the first reference point, and a distance between the location of the terminal device and the second reference point is greater than or equal to a second threshold. Optionally, the terminal device may determine, in the manner described in Implementation 1 or Implementation 2, whether the location of the terminal device is within the distance range of the first reference point.

If the first information is cell-level information, the second reference point may be a reference point of the satellite cell on which the terminal device camps. The first reference point 1 and the first reference point 3 in the scenario shown in FIG. 5 are used as an example. If the location of the terminal device is within a distance range of the first reference point 1, and the distance between the location of the terminal device and the second reference point is greater than or equal to the second threshold, the terminal device measures frequencies of a plurality of neighboring cells (including the ground cell 1, the ground cell 2, and the ground cell 3) corresponding to the first reference point 1. If the location of the terminal device is within a distance range of the first reference point 3, and the distance between the location of the terminal device and the second reference point is greater than or equal to the second threshold, the terminal device measures a frequency of a neighboring cell (namely, the ground cell 6) corresponding to the first reference point 3.

If the first information is beam-level information, the second reference point may be a reference point of the first beam. A scenario shown in FIG. 6 is used as an example. A reference point of the beam 1 is different from a reference point of the beam 2. If the first beam is the beam 1, the second reference point indicates a location within the coverage area of the beam 1. If the first beam is the beam 2, the second reference point indicates a location within the coverage area of the beam 2. For example, the first beam is the beam 1. For a terminal device located within the coverage area of the beam 1, if a location of the terminal device is within the distance range of the first reference point 1, and a distance between the location of the terminal device and the second reference point is greater than or equal to the second threshold, the terminal device measures frequencies of a plurality of neighboring cells (including the ground cell 1, the ground cell 2, and the ground cell 3) corresponding to the first reference point 1. If a location of the terminal device is within a distance range of the first reference point 2, and a distance between the location of the terminal device and the second reference point is greater than or equal to the second threshold, the terminal device measures frequencies of a plurality of neighboring cells (including the ground cell 4 and the ground cell 5) corresponding to the first reference point 2.

Optionally, the first threshold in Implementation 1 and the fourth threshold in Implementation 2 may be set to small values. Smaller values of the first threshold and the fourth threshold indicate that a distance between the terminal device and the first reference point needs to be shorter if the terminal device needs to measure the frequency of the neighboring cell, in other words, a stronger signal is received by the terminal device from the neighboring cell. The second threshold in Implementation 3 may be set to a large value. A larger value of the second threshold indicates that a distance between the terminal device and the second reference point needs to be longer if the terminal device needs to measure the frequency of the neighboring cell, in other words, a weaker signal can be received by the terminal device from the satellite cell.

Implementation 4: The communication method may further include: The terminal device receives third information, where the third information includes an opening angle that uses a third reference point as a vertex and uses a reference direction as an angular bisector. That the terminal device measures the frequency of the at least one neighboring cell corresponding to the first reference point if the location of the terminal device is within the distance range of the first reference point in step S102 may include: The terminal device measures the frequency of the at least one neighboring cell corresponding to the first reference point if the location of the terminal device is within the distance range of the first reference point, and is within a sector area corresponding to the opening angle. Optionally, the terminal device may determine, in the manner described in Implementation 1 or Implementation 2, whether the location of the terminal device is within the distance range of the first reference point.

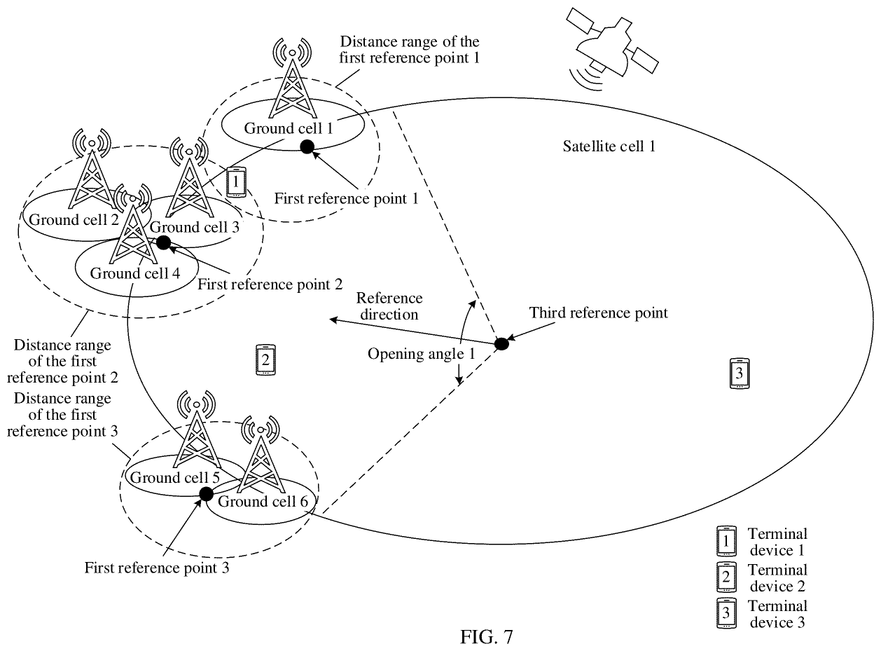

Optionally, if the first information is cell-level information, the third reference point may be a reference point of the satellite cell on which the terminal device camps. For example, with reference to FIG. 7, first information received by a terminal device camping on a satellite cell 1 includes: a first reference point 1 and a frequency f₁ of a ground cell 1 that corresponds to the first reference point 1; a first reference point 2 and a frequency f₂ of a ground cell 2, a frequency f₃ of a ground cell 3, and a frequency f₄ of a ground cell 4 that correspond to the first reference point 2; and a first reference point 3 and a frequency f₅ of a ground cell 5 and a frequency f₆ of a ground cell 6 that correspond to the first reference point 3. Received third information includes an opening angle 1 that uses a third reference point as a vertex and uses a reference direction as an angular bisector. It can be learned from FIG. 7 that a location of a terminal device 1 is within a sector area corresponding to the opening angle 1, and is within a distance range of the first reference point 1 and a distance range of the first reference point 2. In this case, the terminal device 1 may measure f₁, f₂, f₃, and f₄. A location of a terminal device 2 is within the sector area corresponding to the opening angle 1, but is not within a distance range of any first reference point. Therefore, the terminal device 2 may not measure a frequency of a neighboring cell corresponding to any first reference point in the first information. A location of a terminal device 3 is neither within the sector area corresponding to the opening angle 1 nor within the distance range of any first reference point. Therefore, the terminal device 3 may not measure the frequency of the neighboring cell corresponding to any first reference point in the first information.

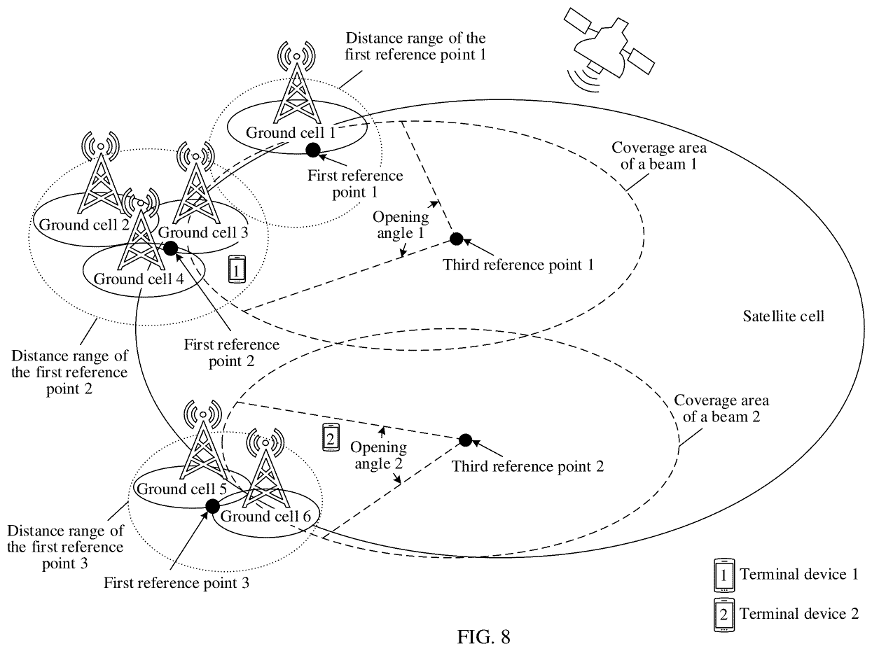

Optionally, if the first information is beam-level information, the third reference point may be a reference point of the first beam. For example, with reference to FIG. 8, in a satellite cell, for a terminal device located within a coverage area of a beam 1, a received first message includes: a first reference point 1 and a frequency f₁ of a ground cell 1 that corresponds to the first reference point 1; and a first reference point 2 and a frequency f₂ of a ground cell 2, a frequency f₃ of a ground cell 3, and a frequency f₄ of a ground cell 4 that correspond to the first reference point 2. Received second information includes an opening angle 1. For a terminal device located within a coverage area of a beam 2, a received first message includes a first reference point 3 and a frequency f₅ of a ground cell 5 and a frequency f₆ of a ground cell 6 that correspond to the first reference point 3. The received second information includes an opening angle 2. It can be learned from FIG. 8 that, within the coverage area of the beam 1, a location of the terminal device 1 is within a sector area corresponding to the opening angle 1, and is within a distance range of the first reference point 2. In this case, the terminal device 1 measures f₂, f₃, and f₄. Within the coverage area of the beam 2, a location of the terminal device 2 is within a sector area of the opening angle 2, but is not within a distance range of the first reference point 3. Therefore, the terminal device 2 may not perform cell measurement on f₅ or f₆.

Implementation 5: The communication method may further include: The terminal device receives second information and third information, where the second information includes a second reference point, and the third information includes an opening angle that uses a third reference point as a vertex and uses a reference direction as an angular bisector. That the terminal device measures the frequency of the at least one neighboring cell corresponding to the first reference point if the location of the terminal device is within the distance range of the first reference point in step S102 may include: The terminal device measures the frequency of the at least one neighboring cell corresponding to the first reference point if the location of the terminal device is within the distance range of the first reference point, and is within a sector area corresponding to the opening angle, and a distance between the location of the terminal device and the second reference point is greater than or equal to a second threshold. Optionally, the third reference point may be the first reference point, or may be the second reference point. Optionally, the terminal device may determine, in the manner described in Implementation 1 or Implementation 2, whether the location of the terminal device is within the distance range of the first reference point.

In addition, for specific descriptions of how the terminal device determines whether the distance between the location of the terminal device and the second reference point is greater than or equal to the second threshold, refer to the related descriptions of Implementation 3. For specific descriptions of how the terminal device determines whether the location of the terminal device is within the sector area corresponding to the opening angle, refer to the related descriptions of Implementation 4.

In an optional implementation, the at least one neighboring cell corresponding to the first reference point is a first neighboring cell or a second neighboring cell. If the neighboring cell to be measured by the terminal device includes the first neighboring cell and the second neighboring cell, that the terminal device measures the frequency of the at least one neighboring cell corresponding to the first reference point may include: The terminal device measures a frequency of the first neighboring cell, where a priority of the first neighboring cell is higher than a priority of the second neighboring cell. If a measurement result meets an access requirement, the terminal device accesses the first neighboring cell; or if a measurement result does not meet an access requirement, the terminal device measures a frequency of the second neighboring cell.

For example, neighboring cells to be measured by the terminal device include a neighboring cell corresponding to the first reference point 1 and a neighboring cell corresponding to the first reference point 2. The neighboring cell corresponding to the first reference point 1 is the first neighboring cell, and the neighboring cell corresponding to the first reference point 2 is the second neighboring cell. In this case, the terminal device first measures a frequency of the neighboring cell corresponding to the first reference point 1. If a measurement result of measuring a frequency of a neighboring cell corresponding to the first reference point 1 by the terminal device meets the access requirement, the terminal device accesses the neighboring cell; or if a measurement result does not meet the access requirement, the terminal device measures a frequency of a neighboring cell corresponding to the first reference point 2. If a measurement result of measuring a frequency of a neighboring cell corresponding to the first reference point 2 meets the access requirement, the terminal device accesses the neighboring cell.

Optionally, the first neighboring cell is a ground cell in the neighboring cell of the satellite cell, and the second neighboring cell is a satellite cell in the neighboring cell of the satellite cell. In other words, for the neighboring cell of the satellite cell, the terminal device may first measure a frequency of the ground cell, and if a measurement result does not meet the access requirement, the terminal device may then measure a frequency of the satellite cell. Optionally, the first neighboring cell is a satellite cell in the neighboring cell of the satellite cell, and the second neighboring cell is a ground cell in the neighboring cell of the satellite cell. In other words, for the neighboring cell of the satellite cell, the terminal device may first measure a frequency of the satellite cell, and if a measurement result does not meet the access requirement, the terminal device may then measure a frequency of the ground cell.

In an optional implementation, if the terminal device measures a plurality of frequencies, the terminal device may measure the plurality of frequencies based on a priority of each of the plurality of frequencies. Measurement of a frequency with a higher priority precedes measurement of a frequency with a lower priority. If a measurement result of measuring the frequency with the higher priority by the terminal device meets the access requirement, the terminal device accesses a neighboring cell corresponding to the frequency, and does not need to measure the frequency with the lower priority; or if a measurement result does not meet the access requirement, the terminal device measures the frequency with the lower priority.

For example, frequencies to be measured by the terminal device include: a frequency f₁ of a neighboring cell 1 and a frequency f₂ of a neighboring cell 2 that correspond to a first reference point 1; and a frequency f₃ of a neighboring cell 3 that corresponds to a first reference point 2, where a priority of f₂ is higher than a priority of f₃, and the priority of f₃ is higher than a priority of f₁. The terminal device may first measure f₁, and if a measurement result meets the access requirement, the terminal device then accesses the neighboring cell 1; or if a measurement result does not meet the access requirement, the terminal device measures f₃, and if a measurement result meets the access requirement, the terminal device accesses the neighboring cell 3. When neither a measurement result of measuring f₁ by the terminal device nor a measurement result of f₃ measuring by the terminal device meets the access requirement, the terminal device measures f₂. If a measurement result meets the access requirement, the terminal device accesses the neighboring cell 2.

In addition, in an optional implementation, the first information sent by the network device in step S101 includes a frequency band of the at least one neighboring cell corresponding to the first reference point, rather than the frequency of the at least one neighboring cell corresponding to the first reference point. In this case, in step S102, the terminal device measures one or more frequencies in the frequency band of the at least one neighboring cell corresponding to the first reference point if the location of the terminal device is within the distance range of the first reference point. This implementation is applicable to a case in which when the network device does not know the frequency of the neighboring cell of the satellite cell, the terminal device may perform cell measurement based on the received frequency band of the neighboring cell of the satellite cell. For example, the first information includes a first reference point 1 and a frequency band 1 of a neighboring cell 1 and a frequency band 2 of a neighboring cell 2 that correspond to the first reference point 1. If the location of the terminal device is within a distance range of the first reference point 1, the terminal device measures one or more frequencies in the frequency band 1 and one or more frequencies in the frequency band 2.

A possible implementation of an operation in which the terminal device measures one or more frequencies in the frequency band of the at least one neighboring cell corresponding to the first reference point if the location of the terminal device is within the distance range of the first reference point is similar to Implementation 1 to Implementation 5.

Optionally, a frequency in any frequency band that the terminal device may need to measure may be determined by the network device and the terminal device through negotiation, or may be uniformly specified in a protocol. This is not limited herein.

In conclusion, in the communication method 100, the terminal device receives the first information, where the first information includes the at least one first reference point and the frequency of the at least one neighboring cell corresponding to the first reference point. The terminal device measures the frequency of the at least one neighboring cell corresponding to the first reference point if the location of the terminal device is within the distance range of the first reference point. Compared with a manner in which the terminal device measures frequencies of all neighboring cells of a satellite cell, this method can reduce power consumption and overheads of the terminal device for cell measurement. In addition, in the method, the first reference point indicates the location in the first area other than the location of the network device to which the at least one neighboring cell corresponding to the first reference point belongs, and the first area includes the coverage area of the at least one neighboring cell corresponding to the first reference point. It can be learned that in a process in which the terminal device performs cell measurement, the location of the network device to which the neighboring cell belongs is not exposed, to avoid introducing a security problem.

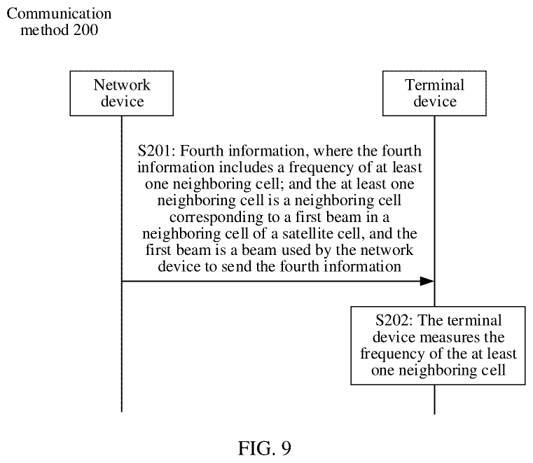

FIG. 9 is a diagram of interaction of a communication method 200 according to an embodiment of this application. The communication method 200 is described from a perspective of interaction between a terminal device and a network device. The terminal device is a terminal device camping on a satellite cell, and the network device is a network device to which the satellite cell belongs. The communication method 200 includes the following steps.

S201: The network device sends fourth information, where the fourth information includes a frequency of at least one neighboring cell; and the at least one neighboring cell is a neighboring cell corresponding to a first beam in a neighboring cell of the satellite cell, and the first beam is a beam used by the network device to send the fourth information. Correspondingly, the terminal device receives the fourth information.

The scenario shown in FIG. 6 is used as an example. Fourth information sent by the network device by using the beam 1 includes the frequency of the ground cell 1, the frequency of the ground cell 2, the frequency of the ground cell 3, the frequency of the ground cell 4, and the frequency of the ground cell 5. The terminal device located within the coverage area of the beam 1 can receive the fourth information. Fourth information sent by the network device by using the beam 2 includes the frequency of the ground cell 6 and the frequency of the satellite cell 2. The terminal device located within the coverage area of the beam 2 can receive the fourth information.

Optionally, that the network device sends the fourth information in step S201 may include: For each of a plurality of beams included in the satellite cell, if there is a cell corresponding to the beam in the neighboring cell of the satellite cell, the network device uses the beam to send fourth information corresponding to the beam. The fourth information corresponding to the beam includes the cell corresponding to the beam in the neighboring cell of the satellite cell. If there is no cell corresponding to the beam in the neighboring cell of the satellite cell, the network device may not send fourth information corresponding to the beam. Correspondingly, if a terminal device located within a coverage area of a beam receives fourth information, it indicates that there is a cell corresponding to the beam in the neighboring cell of the satellite cell. In this case, the terminal device may perform step S202. Alternatively, if a terminal device located within a coverage area of a beam does not receive first information, it indicates that there is no cell corresponding to the beam in the neighboring cell of the satellite cell. In this case, the terminal device may not perform cell measurement. In this manner, power consumption and overheads of the terminal device for cell measurement can be reduced.

S202: The terminal device measures the frequency of the at least one neighboring cell.

In an optional implementation, the method further includes: The terminal device receives fifth information, where the fifth information includes at least one first reference point, and the at least one neighboring cell is at least one neighboring cell corresponding to the first reference point. The first reference point indicates a location in a first area other than a location of the network device to which the at least one neighboring cell corresponding to the first reference point belongs, and the first area includes a coverage area of the at least one neighboring cell corresponding to the first reference point. That the terminal device measures the frequency of the at least one neighboring cell includes: The terminal device measures the frequency of the at least one neighboring cell corresponding to the first reference point if a location of the terminal device is within a distance range of the first reference point. For specific descriptions of this implementation, refer to the related descriptions of the implementation in which the first information is beam-level information in the communication method 100.

In addition, for a specific implementation of an operation in which the terminal device measures the frequency of the at least one neighboring cell corresponding to the first reference point if the location of the terminal device is within the distance range of the first reference point, refer to the related descriptions of Implementation 1 to Implementation 5 in the communication method 100.

In an optional implementation, if the neighboring cell to be measured by the terminal device includes a first neighboring cell and a second neighboring cell, that the terminal device measures frequencies of a plurality of neighboring cells may include: The terminal device measures a frequency of the first neighboring cell, where a priority of the first neighboring cell is higher than a priority of the second neighboring cell. If a measurement result meets an access requirement, the terminal device accesses the first neighboring cell; or if a measurement result does not meet an access requirement, the terminal device measures a frequency of the second neighboring cell. Optionally, the first neighboring cell is a ground cell in the neighboring cell of the satellite cell, and the second neighboring cell is a satellite cell in the neighboring cell of the satellite cell. Optionally, the first neighboring cell is a satellite cell in the neighboring cell of the satellite cell, and the second neighboring cell is a ground cell in the neighboring cell of the satellite cell. For specific descriptions, refer to the related descriptions in the communication method 100.

In an optional implementation, if the terminal device measures a plurality of frequencies, that the terminal device measures the frequencies of the plurality of neighboring cells may include: The terminal device may measure the plurality of frequencies based on a priority of each of the plurality of frequencies. Measurement of a frequency with a higher priority precedes measurement of a frequency with a lower priority. If a measurement result of measuring the frequency with the higher priority by the terminal device meets the access requirement, the terminal device accesses a neighboring cell corresponding to the frequency, and does not need to measure the frequency with the lower priority; or if a measurement result does not meet the access requirement, the terminal device measures the frequency with the lower priority. For specific descriptions, refer to the related descriptions in the communication method 100.

In addition, in an optional implementation, the fourth information sent by the network device in step S201 includes a frequency band of the at least one neighboring cell, rather than the frequency of the at least one neighboring cell. In this case, in step S202, the terminal device measures one or more frequencies in the frequency band of the at least one neighboring cell. This implementation is applicable to a case in which when the network device does not know the frequency of the neighboring cell of the satellite cell, the terminal device may perform cell measurement based on the received frequency band of the neighboring cell of the satellite cell. For example, the fourth information includes a frequency band 1 of a neighboring cell 1 and a frequency band 2 of a neighboring cell 2. In this case, the terminal device measures one or more frequencies in the frequency band 1 and one or more frequencies in the frequency band 2.

Optionally, a frequency in any frequency band that the terminal device may need to measure may be determined by the network device and the terminal device through negotiation, or may be uniformly specified in a protocol. This is not limited herein.

In the communication method 200, the terminal device camping on the satellite cell may receive the fourth information, where the fourth information includes the frequency of the at least one neighboring cell; and the at least one neighboring cell is the cell corresponding to the first beam in the neighboring cell of the satellite cell, and the first beam is the beam corresponding to receiving the fourth information by the terminal device. The terminal device measures the frequency of the at least one neighboring cell. It can be learned that the fourth information received by the terminal device is beam-level information, a frequency that the terminal device may need to measure is a frequency of the cell corresponding to the first beam in the neighboring cell of the satellite cell, and a frequency of a cell that does not correspond to the first beam in the neighboring cell of the satellite cell does not need to be measured. This can reduce power consumption and overheads of the terminal device for cell measurement.

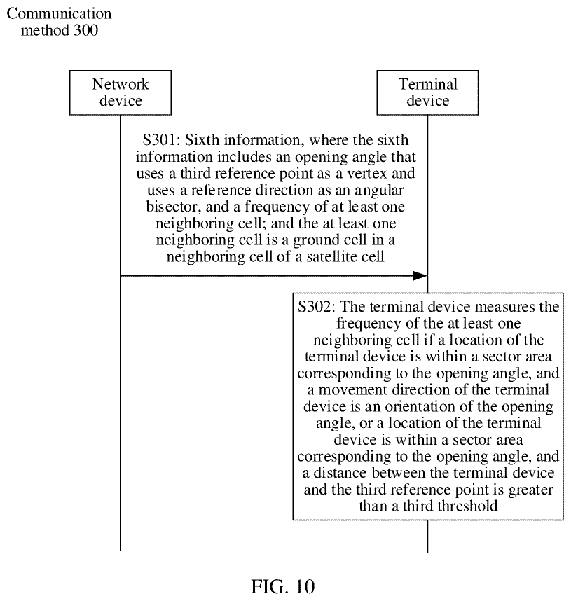

FIG. 10 is a diagram of interaction of a communication method 300 according to an embodiment of this application. The communication method 300 is described from a perspective of interaction between a terminal device and a network device. The terminal device is a terminal device camping on a satellite cell, and the network device is a network device to which the satellite cell belongs. The communication method 300 includes the following steps.

S301: The network device sends sixth information, where the sixth information includes an opening angle that uses a third reference point as a vertex and uses a reference direction as an angular bisector, and a frequency of at least one neighboring cell; and the at least one neighboring cell is a ground cell in a neighboring cell of the satellite cell. Correspondingly, the terminal device receives the sixth information. The reference direction may be any direction that can be learned of by the terminal device. For example, the reference direction may be a satellite movement direction corresponding to the satellite cell. This is not limited herein.

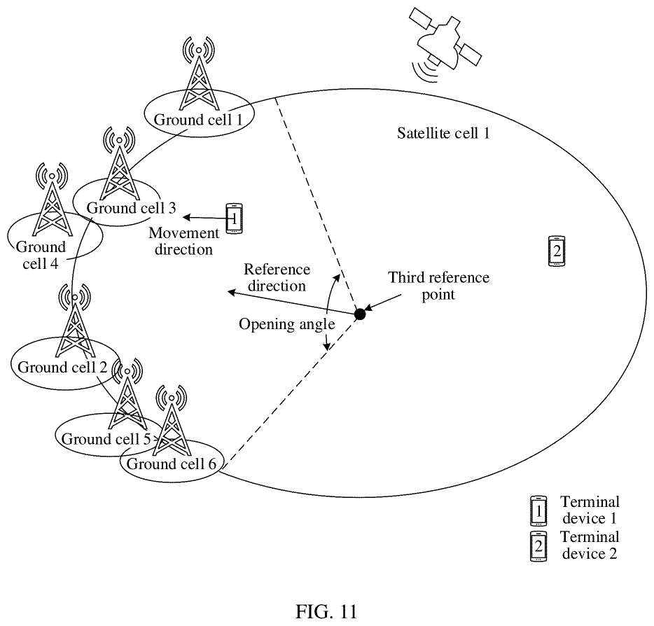

Optionally, the at least one neighboring cell in the sixth information includes all ground cells in neighboring cells of the satellite cell. In other words, the sixth information is cell-level information. The method is applicable to a case in which when ground cells in neighboring cells of the satellite cell are distributed in some directions at an edge of the satellite cell, if a condition in S302 is met, the terminal device performs measurement on the ground cells in the neighboring cells of the satellite cell; or if a condition in S302 is not met, the terminal device may not need to perform measurement on the ground cells in the neighboring cells of the satellite cell. For example, with reference to FIG. 11, sixth information received by a terminal device camping on a satellite cell 1 includes: an opening angle that uses a third reference point as a vertex and uses a reference direction as an angular bisector, a frequency of a ground cell 1, a frequency of a ground cell 2, a frequency of a ground cell 3, a frequency of a ground cell 4, a frequency of a ground cell 5, and a frequency of a ground cell 6.

In addition, if there is no ground cell in the neighboring cell of the satellite cell on which the terminal device camps, the network device may not send the sixth information. In this case, the terminal device may not perform step S302.

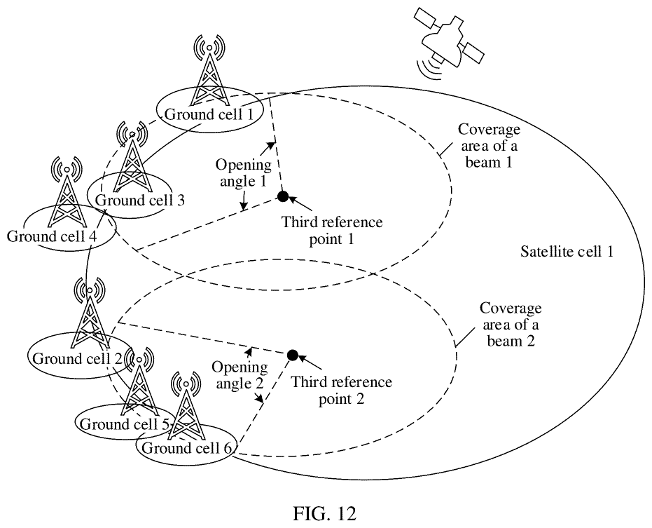

Optionally, the at least one neighboring cell in the sixth information is a ground cell corresponding to a first beam in the neighboring cell of the satellite cell, and the first beam is a beam used by the network device to send the sixth information. In other words, the sixth information is beam-level information. The method is applicable to a case in which when ground cells in cells corresponding to the first beam are distributed in some directions at an edge of a coverage area of the first beam in a centralized manner, if the condition in S302 is met, the terminal device performs measurement on the ground cells in the cells corresponding to the first beam; or if the condition in S302 is not met, the terminal device may not need to perform measurement on the ground cells in the cells corresponding to the first beam. In this manner, power consumption and overheads of the terminal device for cell measurement can be reduced. For example, with reference to FIG. 12, sixth information sent by the network device by using a beam 1 includes an opening angle 1, a frequency of a ground cell 1, a frequency of a ground cell 3, and a frequency of a ground cell 4. A terminal device located within a coverage area of the beam 1 can receive the sixth information. Sixth information sent by the network device by using a beam 2 includes an opening angle 2, a frequency of a ground cell 2, a frequency of a ground cell 5, and a frequency of a ground cell 6. A terminal device located within a coverage area of the beam 2 can receive the sixth information.

Optionally, that the network device sends the sixth information in step S301 may include: For each of a plurality of beams included in the satellite cell, if there is a ground cell corresponding to the beam in the neighboring cell of the satellite cell, the network device uses the beam to send sixth information corresponding to the beam. The sixth information corresponding to the beam includes an opening angle that uses a third reference point as a vertex and uses a reference direction as an angular bisector, and a frequency of the ground cell corresponding to the beam in the neighboring cell of the satellite cell. If there is no ground cell corresponding to a beam in the neighboring cell of the satellite cell, the network device may not send sixth information corresponding to the beam. Correspondingly, if a terminal device located within a coverage area of a beam receives sixth information, it indicates that there is a ground cell corresponding to the beam in the neighboring cell of the satellite cell. In this case, the terminal device may perform step S302. Alternatively, if a terminal device located within a coverage area of a beam does not receive sixth information, it indicates that there is no ground cell corresponding to the beam in the neighboring cell of the satellite cell. In this case, the terminal device may not perform step S302. In this manner, power consumption and overheads of the terminal device for cell measurement can be reduced.

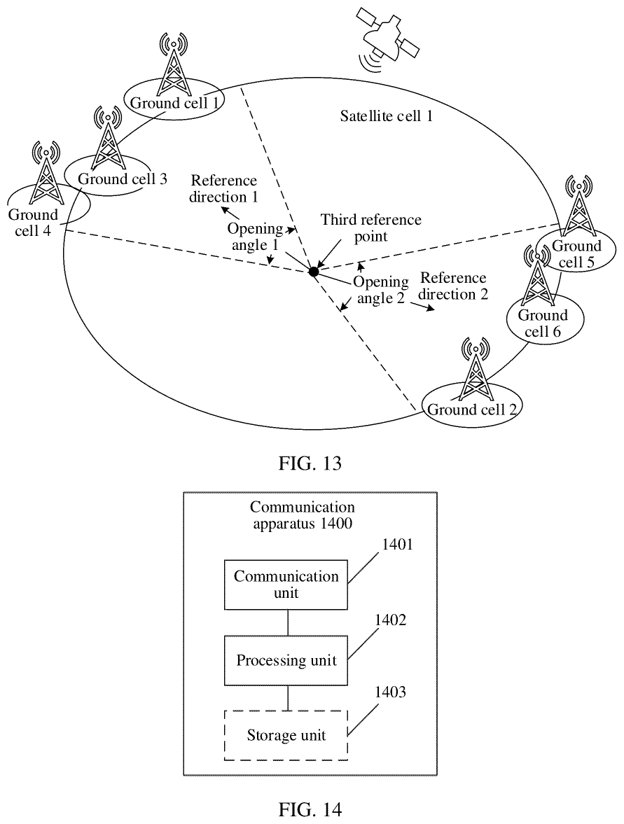

In an optional implementation, there may be a plurality of opening angles in the sixth information, vertices of the plurality of opening angles are a same third reference point, and reference directions corresponding to angular bisectors of the plurality of opening angles are different. This manner is applicable to a case in which ground cells are distributed in a plurality of directions in a centralized manner. In this case, the sixth information may include the plurality of opening angles and a frequency of at least one neighboring cell corresponding to each opening angle, and the at least one neighboring cell corresponding to each opening angle is a ground cell in the neighboring cell of the satellite cell. In addition, the sixth information may be cell-level information, or may be beam-level information. For example, the sixth information is cell-level information. With reference to FIG. 13, in neighboring cells of a satellite cell 1, there are ground cells distributed in two directions in a centralized manner. In this case, sixth information sent by the network device includes: an opening angle 1 that uses a third reference point as a vertex and uses a reference direction 1 as an angular bisector, a frequency of a ground cell 1, a frequency of a ground cell 3, and a frequency of a ground cell 4 that correspond to the opening angle 1, an opening angle 2 that uses a third reference point as a vertex and uses a reference direction 2 as an angular bisector, and a frequency of a ground cell 2, a frequency of a ground cell 5, and a frequency of a ground cell 6 that correspond to the opening angle 2.

S302: The terminal device measures the frequency of the at least one neighboring cell if a location of the terminal device is within a sector area corresponding to the opening angle, and a movement direction of the terminal device is an orientation of the opening angle, or a location of the terminal device is within a sector area corresponding to the opening angle, and a distance between the terminal device and the third reference point is greater than a third threshold.

The scenario shown in FIG. 11 is used as an example. A location of a terminal device 1 is within a sector area corresponding to an opening angle, and a movement direction of the terminal device is an orientation of the opening angle. In this case, the terminal device 1 needs to measure the frequency of the ground cell 1, the frequency of the ground cell 2, the frequency of the ground cell 3, the frequency of the ground cell 4, the frequency of the ground cell 5, and the frequency of the ground cell 6. A location of a terminal device 2 is not within the sector area corresponding to the opening angle. In this case, the terminal device 2 may not need to measure the frequencies of the ground cell 1 to the ground cell 6.

Optionally, the third threshold in step S302 may be set to a large value. If the sixth information is cell-level information, a larger value of the third threshold indicates that a distance between the terminal device and the third reference point needs to be longer if the terminal device needs to measure the frequency of the neighboring cell. In other words, if the terminal device is closer to a ground cell located at an edge of the satellite cell, a stronger signal can be received by the terminal device from the ground cell. Similarly, if the sixth information is beam-level information, a larger value of the third threshold indicates that a distance between the terminal device and the third reference point needs to be longer if the terminal device needs to measure the frequency of the neighboring cell. In other words, if the terminal device is closer to a ground cell located at an edge of the coverage area of the beam, a stronger signal can be received by the terminal device from the ground cell.

Optionally, the communication method may further include: The network device sends a satellite cell in the neighboring cell of the satellite cell on which the terminal device camps. If the location of the terminal device is within the sector area corresponding to the opening angle, and the movement direction of the terminal device is the orientation of the opening angle, or the location of the terminal device is within the sector area corresponding to the opening angle, and the distance between the terminal device and the third reference point is greater than the third threshold, the terminal device measures the frequency of the at least one neighboring cell and a frequency of the satellite cell in the neighboring cell of the satellite cell. Otherwise, the terminal device measures a frequency of the satellite cell in the neighboring cell of the satellite cell.

In an optional implementation, the method further includes: The terminal device receives fifth information, where the fifth information includes at least one first reference point, and the at least one neighboring cell in the sixth information is at least one neighboring cell corresponding to the first reference point. The first reference point indicates a location in a first area other than a location of the network device to which the at least one neighboring cell corresponding to the first reference point belongs, and the first area includes a coverage area of the at least one neighboring cell corresponding to the first reference point. That the terminal device measures the frequency of the at least one neighboring cell in step S302 may include: The terminal device measures the frequency of the at least one neighboring cell corresponding to the first reference point if the location of the terminal device is within a distance range of the first reference point.

In addition, for a specific implementation of an operation in which the terminal device measures the frequency of the at least one neighboring cell corresponding to the first reference point if the location of the terminal device is within the distance range of the first reference point, refer to the related descriptions of Implementation 1 to Implementation 5 in the communication method 100.

In an optional implementation, if the neighboring cell to be measured by the terminal device includes a first neighboring cell and a second neighboring cell, that the terminal device measures the frequency of the at least one neighboring cell may include: The terminal device measures a frequency of the first neighboring cell, where a priority of the first neighboring cell is higher than a priority of the second neighboring cell. If a measurement result meets an access requirement, the terminal device accesses the first neighboring cell; or if a measurement result does not meet an access requirement, the terminal device measures a frequency of the second neighboring cell. Optionally, the first neighboring cell is a ground cell in the neighboring cell of the satellite cell, and the second neighboring cell is a satellite cell in the neighboring cell of the satellite cell. Optionally, the first neighboring cell is a satellite cell in the neighboring cell of the satellite cell, and the second neighboring cell is a ground cell in the neighboring cell of the satellite cell. For specific descriptions, refer to the related descriptions in the communication method 100.

In an optional implementation, if the terminal device measures a plurality of frequencies, that the terminal device measures the frequencies of the plurality of neighboring cells may include: The terminal device may measure the plurality of frequencies based on a priority of each of the plurality of frequencies. Measurement of a frequency with a higher priority precedes measurement of a frequency with a lower priority. If a measurement result of measuring the frequency with the higher priority by the terminal device meets the access requirement, the terminal device accesses a neighboring cell corresponding to the frequency, and does not need to measure the frequency with the lower priority; or if a measurement result does not meet the access requirement, the terminal device measures the frequency with the lower priority. For specific descriptions, refer to the related descriptions in the communication method 100.

In addition, in an optional implementation, the sixth information sent by the network device in step S301 includes a frequency band of the at least one neighboring cell, rather than the frequency of the at least one neighboring cell. In step S302, the terminal device measures one or more frequencies in the frequency band of the at least one neighboring cell if the location of the terminal device is within the sector area corresponding to the opening angle, and the movement direction of the terminal device is the orientation of the opening angle, or the location of the terminal device is within the sector area corresponding to the opening angle, and the distance between the terminal device and the third reference point is greater than the third threshold. This implementation is applicable to a case in which when the network device does not know the frequency of the neighboring cell of the satellite cell, the terminal device may perform cell measurement based on the received frequency band of the neighboring cell of the satellite cell. Optionally, a frequency in any frequency band that the terminal device may need to measure may be determined by the network device and the terminal device through negotiation, or may be uniformly specified in a protocol. This is not limited herein.

In the communication method 300, the terminal device receives the sixth information, where the sixth information includes the opening angle that uses the third reference point as the vertex and uses the reference direction as the angular bisector, and the frequency of the at least one neighboring cell; and the at least one neighboring cell is the ground cell in the neighboring cell of the satellite cell. The terminal device measures the frequency of the at least one neighboring cell if the location of the terminal device is within the sector area corresponding to the opening angle, and the movement direction of the terminal device is the orientation of the opening angle, or the location of the terminal device is within the sector area corresponding to the opening angle, and the distance between the terminal device and the third reference point is greater than the third threshold. It can be learned that the terminal device may determine, depending on whether the foregoing requirement is met, whether to measure the frequency of the at least one neighboring cell in the sixth information. Compared with a manner in which the terminal device directly measures frequencies of all neighboring cells of the satellite cell, this manner can reduce power consumption and overheads of the terminal device for cell measurement.

To implement functions in the method provided in the foregoing embodiments of this application, the network device or the terminal device may include a hardware structure and/or a software module, and implement the foregoing functions in a form of the hardware structure, the software module, or a combination of the hardware structure and the software module. Whether a function in the foregoing functions is performed by using the hardware structure, the software module, or the combination of the hardware structure and the software module depends on particular applications and design constraints of the technical solutions.

As shown in FIG. 14, an embodiment of this application provides a communication apparatus 1400. The communication apparatus 1400 may be a component (for example, an integrated circuit or a chip) of a network device, or may be a component (for example, an integrated circuit or a chip) of a terminal device. Alternatively, the communication apparatus 1400 may be another communication unit, configured to implement the method in method embodiments of this application. The communication apparatus 1400 may include a communication unit 1401 and a processing unit 1402. The processing unit 1402 is configured to control the communication unit 1401 to perform data/signaling receiving and sending. Optionally, the communication apparatus 1400 may further include a storage unit 1403.

In a possible implementation, the communication unit 1401 is configured to receive first information, where the first information includes at least one first reference point and a frequency of at least one neighboring cell corresponding to the first reference point. The first reference point indicates a location in a first area other than a location of a network device to which the at least one neighboring cell corresponding to the first reference point belongs, and the first area includes a coverage area of the at least one neighboring cell corresponding to the first reference point.

The processing unit 1402 is configured to measure the frequency of the at least one neighboring cell corresponding to the first reference point if a location of the communication apparatus 1400 is within a distance range of the first reference point.

In an optional implementation, if the location of the communication apparatus 1400 is within the distance range of the first reference point, when measuring the frequency of the at least one neighboring cell corresponding to the first reference point, the processing unit 1402 is specifically configured to:

measure, by the processing unit 1402, a first frequency if a distance between the location of the communication apparatus 1400 and the first reference point is less than or equal to a first threshold corresponding to the first frequency, where the first frequency is a frequency in the frequency of the at least one neighboring cell corresponding to the first reference point.

Optionally, the first reference point corresponds to one frequency, and the frequency corresponds to one first threshold.

Optionally, the first reference point corresponds to a plurality of frequencies. The plurality of frequencies correspond to a same first threshold, or the plurality of frequencies correspond to at least two different first thresholds.

In an optional implementation, the communication unit 1401 is further configured to receive second information, where the second information includes a second reference point.

If the location of the communication apparatus 1400 is within the distance range of the first reference point, when measuring the frequency of the at least one neighboring cell corresponding to the first reference point, the processing unit 1402 is specifically configured to:

measure, by the processing unit 1402, the frequency of the at least one neighboring cell corresponding to the first reference point if the location of the communication apparatus 1400 is within the distance range of the first reference point, and a distance between the location of the communication apparatus 1400 and the second reference point is greater than or equal to a second threshold.

In an optional implementation, the communication unit 1401 is further configured to receive third information, where the third information includes an opening angle that uses a third reference point as a vertex and uses a reference direction as an angular bisector.

If the location of the communication apparatus 1400 is within the distance range of the first reference point, when measuring the frequency of the at least one neighboring cell corresponding to the first reference point, the processing unit 1402 is specifically configured to:

measure, by the processing unit 1402, the frequency of the at least one neighboring cell corresponding to the first reference point if the location of the communication apparatus 1400 is within the distance range of the first reference point, and is within a sector area corresponding to the opening angle.

In an optional implementation, the at least one neighboring cell corresponding to the first reference point is a cell corresponding to a first beam in a neighboring cell of a satellite cell, and the first beam is a beam corresponding to receiving the first information by the communication unit 1401.

In an optional implementation, the at least one neighboring cell corresponding to the first reference point is a first neighboring cell or a second neighboring cell.

if the neighboring cell to be measured by the processing unit 1402 includes the first neighboring cell and the second neighboring cell, when measuring the frequency of the at least one neighboring cell corresponding to the first reference point, the processing unit 1402 is specifically configured to:

measure, by the processing unit 1402, a frequency of the first neighboring cell, where a priority of the first neighboring cell is higher than a priority of the second neighboring cell; and if a measurement result meets an access requirement, access, by the processing unit 1402, the first neighboring cell; or if a measurement result does not meet an access requirement, measure, by the processing unit 1402, a frequency of the second neighboring cell.

Optionally, the first neighboring cell is a ground cell in the neighboring cell of the satellite cell, and the second neighboring cell is a satellite cell in the neighboring cell of the satellite cell.

In another possible implementation, the communication unit 1401 is configured to send first information, where the first information includes at least one first reference point and a frequency of at least one neighboring cell corresponding to the first reference point; and the first reference point indicates a location in a first area other than a location of a network device to which the at least one neighboring cell corresponding to the first reference point belongs, and the first area includes a coverage area of the at least one neighboring cell corresponding to the first reference point.

In an optional implementation, the communication unit 1401 is further configured to send second information, where the second information includes a second reference point.

In an optional implementation, the communication unit 1401 is further configured to send third information, where the third information includes an opening angle that uses a third reference point as a vertex and uses a reference direction as an angular bisector.

In an optional implementation, the at least one neighboring cell corresponding to the first reference point is a cell corresponding to a first beam in a neighboring cell of a satellite cell, where the first beam is a beam used by the communication unit 1401 to send the first information.

This embodiment of this application and the foregoing communication method 100 are based on a same concept, and bring same technical effect. For a specific principle, refer to the descriptions of the foregoing embodiments.

In another possible implementation, the communication unit 1401 is configured to receive fourth information, where the fourth information includes a frequency of at least one neighboring cell; and the at least one neighboring cell is a cell corresponding to a first beam in a neighboring cell of a satellite cell, and the first beam is a beam corresponding to receiving the fourth information by the communication unit 1401.

The processing unit 1402 is configured to measure the frequency of the at least one neighboring cell.

In an optional implementation, the communication unit 1401 is further configured to receive fifth information, where the fifth information includes at least one first reference point, and the at least one neighboring cell is at least one neighboring cell corresponding to the first reference point. The first reference point indicates a location in a first area other than a location of a network device to which the at least one neighboring cell corresponding to the first reference point belongs, and the first area includes a coverage area of the at least one neighboring cell corresponding to the first reference point.

When measuring the frequency of the at least one neighboring cell, the processing unit 1402 is specifically configured to measure, by the processing unit 1402, the frequency of the at least one neighboring cell corresponding to the first reference point if a location of the communication apparatus 1400 is within a distance range of the first reference point.

In an optional implementation, if the location of the communication apparatus 1400 is within the distance range of the first reference point, when measuring the frequency of the at least one neighboring cell corresponding to the first reference point, the processing unit 1402 is specifically configured to:

measure, by the processing unit 1402, the first frequency if a distance between the location of the communication apparatus 1400 and the first reference point is less than or equal to a first threshold corresponding to a first frequency, where the first frequency is a frequency in the frequency of the at least one neighboring cell corresponding to the first reference point.

Optionally, the first reference point corresponds to one frequency, and the frequency corresponds to one first threshold.

Optionally, the first reference point corresponds to a plurality of frequencies. The plurality of frequencies correspond to a same first threshold, or the plurality of frequencies correspond to at least two different first thresholds.

In an optional implementation, the communication unit 1401 is further configured to receive second information, where the second information includes a second reference point.

If the location of the communication apparatus 1400 is within the distance range of the first reference point, when measuring the frequency of the at least one neighboring cell corresponding to the first reference point, the processing unit 1402 is specifically configured to:

measure, by the processing unit 1402, the frequency of the at least one neighboring cell corresponding to the first reference point if the location of the communication unit 1401 is within the distance range of the first reference point, and a distance between the location of the communication unit 1401 and the second reference point is greater than or equal to a second threshold.

In an optional implementation, the communication unit 1401 is further configured to receive third information, where the third information includes an opening angle that uses a third reference point as a vertex and uses a reference direction as an angular bisector.

If the location of the communication apparatus 1400 is within the distance range of the first reference point, when measuring the frequency of the at least one neighboring cell corresponding to the first reference point, the terminal device is specifically configured to:

measure, by the processing unit 1402, the frequency of the at least one neighboring cell corresponding to the first reference point if the location of the communication apparatus 1400 is within the distance range of the first reference point, and is within a sector area corresponding to the opening angle.

In an optional implementation, if the neighboring cell to be measured by the processing unit 1402 includes a first neighboring cell and a second neighboring cell, when measuring the frequency of the at least one neighboring cell, the processing unit 1402 is specifically configured to:

measure, by the processing unit 1402, a frequency of the first neighboring cell, where a priority of the first neighboring cell is higher than a priority of the second neighboring cell; and if a measurement result meets an access requirement, access, by the processing unit 1402, the first neighboring cell; or if a measurement result does not meet an access requirement, measure, by the processing unit 1402, a frequency of the second neighboring cell.

Optionally, the first neighboring cell is a ground cell in the neighboring cell of the satellite cell, and the second neighboring cell is a satellite cell in the neighboring cell of the satellite cell.

In another possible implementation, the communication unit 1401 is configured to send fourth information, where the fourth information includes a frequency of at least one neighboring cell; and the at least one neighboring cell is a cell corresponding to a first beam in a neighboring cell of a satellite cell, and the first beam is a beam used by the communication unit 1401 to send the fourth information.

In an optional implementation, the communication unit 1401 is further configured to send fifth information, where the fifth information includes at least one first reference point, and the at least one neighboring cell is at least one neighboring cell corresponding to the first reference point. The first reference point indicates a location in a first area other than a location of a network device to which the at least one neighboring cell corresponding to the first reference point belongs, and the first area includes a coverage area of the at least one neighboring cell corresponding to the first reference point.

In an optional implementation, the communication unit 1401 is further configured to send second information, where the second information includes a second reference point.

In an optional implementation, the communication unit 1401 is further configured to send third information, where the third information includes an opening angle that uses a third reference point as a vertex and uses a reference direction as an angular bisector.

This embodiment of this application and the foregoing communication method 200 are based on a same concept, and bring same technical effect. For a specific principle, refer to the descriptions of the foregoing embodiments.

In another possible implementation, the communication unit 1401 is configured to receive sixth information, where the sixth information includes an opening angle that uses a third reference point as a vertex and uses a reference direction as an angular bisector, and a frequency of at least one neighboring cell; and the at least one neighboring cell is a ground cell in a neighboring cell of a satellite cell.

The processing unit 1402 is configured to measure the frequency of the at least one neighboring cell if a location of the communication apparatus 1400 is within a sector area corresponding to the opening angle, and a movement direction of the communication apparatus 1400 is an orientation of the opening angle, or if a location of the communication apparatus 1400 is within a sector area corresponding to the opening angle, and a distance between the communication apparatus 1400 and the third reference point is greater than a third threshold.

Optionally, the at least one neighboring cell is a cell corresponding to a first beam in the neighboring cell of the satellite cell, and the first beam is a beam corresponding to receiving the sixth information by the communication unit 1401.

In an optional implementation, the communication unit 1401 is further configured to receive fifth information, where the fifth information includes at least one first reference point, and the at least one neighboring cell is at least one neighboring cell corresponding to the first reference point. The first reference point indicates a location in a first area other than a location of a network device to which the at least one neighboring cell corresponding to the first reference point belongs, and the first area includes a coverage area of the at least one neighboring cell corresponding to the first reference point.

When measuring the frequency of the at least one neighboring cell, the processing unit 1402 is specifically configured to measure, by the processing unit 1402, the frequency of the at least one neighboring cell corresponding to the first reference point if a location of the communication apparatus 1400 is within a distance range of the first reference point.

In an optional implementation, if the location of the communication apparatus 1400 is within the distance range of the first reference point, when measuring the frequency of the at least one neighboring cell corresponding to the first reference point, the processing unit 1402 is specifically configured to:

measure, by the processing unit 1402, a first frequency if a distance between the location of the communication apparatus 1400 and the first reference point is less than or equal to a first threshold corresponding to the first frequency, where the first frequency is a frequency in the frequency of the at least one neighboring cell corresponding to the first reference point.

Optionally, the first reference point corresponds to one frequency, and the frequency corresponds to one first threshold.

Optionally, the first reference point corresponds to a plurality of frequencies. The plurality of frequencies correspond to a same first threshold, or the plurality of frequencies correspond to at least two different first thresholds.

In an optional implementation, the communication unit 1401 is further configured to receive second information, where the second information includes a second reference point.

If the location of the communication apparatus 1400 is within the distance range of the first reference point, when measuring the frequency of the at least one neighboring cell corresponding to the first reference point, the processing unit 1402 is specifically configured to:

measure, by the processing unit 1402, the frequency of the at least one neighboring cell corresponding to the first reference point if the location of the communication apparatus 1400 is within the distance range of the first reference point, and a distance between the location of the communication apparatus 1400 and the second reference point is greater than or equal to a second threshold.

In an optional implementation, if the neighboring cell to be measured by the communication apparatus 1400 includes a first neighboring cell and a second neighboring cell, when measuring the frequency of the at least one neighboring cell, the processing unit 1402 is specifically configured to:

measure, by the processing unit 1402, a frequency of the first neighboring cell, where a priority of the first neighboring cell is higher than a priority of the second neighboring cell; and if a measurement result meets an access requirement, access, by the processing unit 1402, the first neighboring cell; or if a measurement result does not meet an access requirement, measure, by the processing unit 1402, a frequency of the second neighboring cell.

Optionally, the first neighboring cell is a ground cell in the neighboring cell of the satellite cell, and the second neighboring cell is a satellite cell in the neighboring cell of the satellite cell.

In another possible implementation, the communication unit 1401 is configured to send sixth information, where the sixth information includes an opening angle that uses a third reference point as a vertex and uses a reference direction as an angular bisector, and a frequency of at least one neighboring cell; and the at least one neighboring cell is a ground cell in a neighboring cell of a satellite cell.

Optionally, the at least one neighboring cell is a cell corresponding to a first beam in the neighboring cell of the satellite cell, where the first beam is a beam used by the communication unit 1401 to send the sixth information.

In an optional implementation, the communication unit 1401 is further configured to send fifth information, where the fifth information includes at least one first reference point, and the at least one neighboring cell is at least one neighboring cell corresponding to the first reference point. The first reference point indicates a location in a first area other than a location of a network device to which the at least one neighboring cell corresponding to the first reference point belongs, and the first area includes a coverage area of the at least one neighboring cell corresponding to the first reference point.

In an optional implementation, the communication unit 1401 is further configured to send second information, where the second information includes a second reference point.

This embodiment of this application and the foregoing communication method 300 are based on a same concept, and bring same technical effect. For a specific principle, refer to the descriptions of the foregoing embodiments.

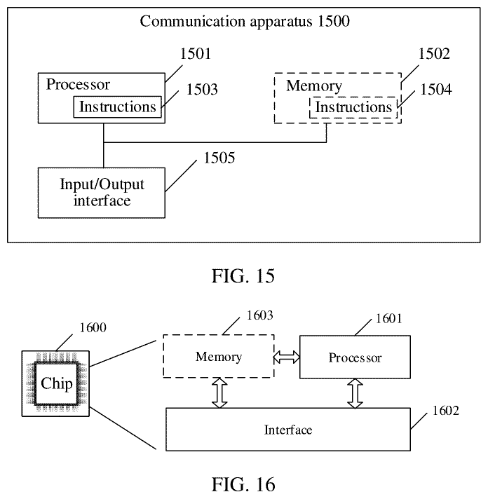

An embodiment of this application further provides a communication apparatus 1500, as shown in FIG. 15. The communication apparatus 1500 may be a network device or a terminal device, may be a chip, a chip system, a processor, or the like that supports the network device in implementing the foregoing methods, or may be a chip, a chip system, a processor, or the like that supports the terminal device in implementing the foregoing methods. The apparatus may be configured to implement the methods described in the foregoing method embodiments For details, refer to the descriptions in the foregoing method embodiments.

The communication apparatus 1500 may include at least one processor 1501. The processor 1501 may be a general-purpose processor, a dedicated processor, or the like. For example, the processor may be a baseband processor, a digital signal processor, an application-specific integrated circuit, a field programmable gate array or another programmable logic device, a discrete gate or a transistor logic device, a discrete hardware component, or a central processing unit (CPU). The baseband processor may be configured to process a communication protocol and communication data. The central processing unit may be configured to control the communication apparatus (for example, a base station, a baseband chip, a terminal, a terminal chip, a distributed unit (DU), or a central unit (CU)), execute a software program, and process data of the software program.

Optionally, the communication apparatus 1500 may include at least one memory 1502. The memory 1502 may store instructions 1504, and the instructions may be run on the processor 1501, to enable the communication apparatus 1500 to perform the methods described in the foregoing method embodiments. Optionally, the memory 1502 may further store data. The processor 1501 and the memory 1502 may be disposed separately, or may be integrated together.

The memory 1502 may include but is not limited to a non-volatile memory like a hard disk drive (HDD) or a solid-state drive (SSD), a random access memory (RAM), an erasable programmable read-only memory (EPROM), a ROM, a compact disc read-only memory (CD-ROM), or the like.

Optionally, the communication apparatus 1500 may further include an input/output interface 1505. The input/output interface 1505 may be referred to as a transceiver unit, a transceiver, a transceiver circuit, or the like, and is configured to implement a transceiver function. The input/output interface 1505 may include an output interface and an input interface. The input interface may be configured to implement a receiving function, and the output interface may be configured to implement a sending function.

When the communication apparatus 1500 is a network device, the input/output interface 1505 is configured to perform S101 in the communication method 100 shown in FIG. 3, perform S201 in the communication method 200 shown in FIG. 9, and perform S301 in the communication method 300 shown in FIG. 10.

When the communication apparatus 1500 is a terminal device, the input/output interface 1505 is configured to perform S101 in the communication method shown in FIG. 3, perform S201 in the communication method shown in FIG. 9, and perform S301 in the communication method shown in FIG. 10. The processor 1501 is configured to perform S102 in the communication method shown in FIG. 3, perform S202 in the communication method shown in FIG. 9, and perform S302 in the communication method shown in FIG. 10.

In another possible implementation, the processor 1501 may include an input/output interface configured to implement receiving and sending functions. The input/output interface may be configured to read and write code/data, or the input/output interface may be configured to transmit or transfer a signal.

In still another possible implementation, optionally, the processor 1501 may store instructions 1503. When the instructions 1503 are run on the processor 1501, the communication apparatus 1500 may be enabled to perform the methods described in the foregoing method embodiments. The instructions 1503 may be fixed in the processor 1501. In this case, the processor 1501 may be implemented by hardware.

In still another possible implementation, the communication apparatus 1500 may include a circuit. The circuit may implement a sending, receiving, or communication function in the foregoing method embodiments. The processor and the input/output interface described in this embodiment of this application may be implemented on an integrated circuit (IC), an analog IC, a radio frequency integrated circuit (RFIC), a mixed-signal IC, an application-specific integrated circuit (ASIC), a printed circuit board (PCB), an electronic device, or the like. The processor and the input/output interface may alternatively be manufactured by using various IC technologies, for example, a complementary metal oxide semiconductor (CMOS), an n-channel metal oxide semiconductor (nMetal-oxide-semiconductor, NMOS), a p-channel metal oxide semiconductor (positive channel metal oxide semiconductor, PMOS), a bipolar junction transistor (BJT), a bipolar CMOS (BiCMOS), silicon germanium (SiGe), and gallium arsenide (GaAs).

The communication apparatus described in the foregoing embodiments may be a network device or a terminal device. However, a scope of the communication apparatus described in embodiments of this application is not limited thereto, and a structure of the communication apparatus may not be limited by FIG. 15. The communication apparatus may be an independent device or may be a part of a large device. For example, the communication apparatus may be:
(1) an independent integrated circuit IC., a chip, or a chip system or subsystem;
(2) a set having at least one IC, where optionally, the IC set may alternatively include a storage component configured to store data and instructions;
(3) an ASIC, for example, a modem (modulator);
(4) a module that can be embedded in another device;
(5) a receiver, a terminal, an intelligent terminal, a cellular phone, a wireless device, a handheld device, a mobile unit, a vehicle-mounted device, a network device, a cloud device, an artificial intelligence device, or the like; or
(6) others.

For a case in which the communication apparatus is a chip or a chip system, refer to a diagram of a structure of a chip shown in FIG. 16. A chip 1600 shown in FIG. 16 includes a processor 1601 and an interface 1602. There may be at least one processor 1601, and there may be a plurality of interfaces 1602. The processor 1601 may be a logic circuit, and the interface 1602 may be an input/output interface, an input interface, or an output interface. The chip 1600 may further include a memory 1603.

In a implementation, when the chip is configured to implement a function of the terminal device in embodiments of this application:

In an optional implementation, the interface 1602 is configured to receive first information, where the first information includes at least one first reference point and a frequency of at least one neighboring cell corresponding to the first reference point. The first reference point indicates a location in a first area other than a location of a network device to which the at least one neighboring cell corresponding to the first reference point belongs, and the first area includes a coverage area of the at least one neighboring cell corresponding to the first reference point.

The processor 1601 is configured to measure the frequency of the at least one neighboring cell corresponding to the first reference point if a location of the chip 1600 is within a distance range of the first reference point.

In another optional implementation, the interface 1602 is configured to receive fourth information, where the fourth information includes a frequency of at least one neighboring cell; and the at least one neighboring cell is a cell corresponding to a first beam in a neighboring cell of a satellite cell, and the first beam is a beam corresponding to receiving the fourth information by the interface 1602.

The processor 1601 is configured to measure the frequency of the at least one neighboring cell.

In still another optional implementation, the interface 1602 is configured to receive sixth information, where the sixth information includes an opening angle that uses a third reference point as a vertex and uses a reference direction as an angular bisector, and a frequency of at least one neighboring cell; and the at least one neighboring cell is a ground cell in a neighboring cell of a satellite cell.

The processor 1601 is configured to measure the frequency of the at least one neighboring cell if a location of the chip 1600 is within a sector area corresponding to the opening angle, and a movement direction of the chip 1600 is an orientation of the opening angle, or if a location of the chip 1600 is within a sector area corresponding to the opening angle, and a distance between the chip 1600 and the third reference point is greater than a third threshold.

In another implementation, when the chip is configured to implement a function of the network device in embodiments of this application:

In an optional implementation, the interface 1602 is configured to send first information, where the first information includes at least one first reference point and a frequency of at least one neighboring cell corresponding to the first reference point; and the first reference point indicates a location in a first area other than a location of a network device to which the at least one neighboring cell corresponding to the first reference point belongs, and the first area includes a coverage area of the at least one neighboring cell corresponding to the first reference point.

In another optional implementation, the interface 1602 is configured to send fourth information, where the fourth information includes a frequency of at least one neighboring cell; and the at least one neighboring cell is a cell corresponding to a first beam in a neighboring cell of a satellite cell, and the first beam is a beam used by the interface 1602 to send the fourth information.

In still another optional implementation, the interface 1602 is configured to send sixth information, where the sixth information includes an opening angle that uses a third reference point as a vertex and uses a reference direction as an angular bisector, and a frequency of at least one neighboring cell; and the at least one neighboring cell is a ground cell in a neighboring cell of a satellite cell.

In embodiments of this application, the communication apparatus 1500 and the chip 1600 may further perform the implementations of the foregoing communication apparatus 1400. A person skilled in the art may further understand that various illustrative logical blocks (illustrative logic blocks) and steps (steps) that are listed in embodiments of this application may be implemented by using electronic hardware, computer software, or a combination thereof. Whether the functions are implemented by using hardware or software depends on particular applications and a design requirement of the entire system. A person skilled in the art may use various methods to implement the described functions for each particular application, but it should not be considered that the implementation goes beyond the protection scope of embodiments of this application.

This embodiment of this application, the foregoing communication method 100 shown in FIG. 3, the foregoing communication method 200 shown in FIG. 9, and the foregoing communication method 300 shown in FIG. 10 are based on a same concept, and bring same technical effects. For a specific principle, refer to the descriptions in the foregoing communication method 100 shown in FIG. 3, the foregoing communication method 200 shown in FIG. 9, and the foregoing communication method 300 shown in FIG. 10.

A person skilled in the art may further understand that various illustrative logical blocks (illustrative logic blocks) and steps (steps) that are listed in embodiments of this application may be implemented by using electronic hardware, computer software, or a combination thereof. Whether the functions are implemented by using hardware or software depends on particular applications and a design requirement of the entire system. A person skilled in the art may use various methods to implement the described functions for each particular application, but it should not be considered that the implementation goes beyond the protection scope of embodiments of this application.

This application further provides a computer-readable storage medium, configured to store computer software instructions. When the instructions are executed by a communication apparatus, a function in any one of the foregoing method embodiments is implemented.

This application further provides a computer program product, configured to store computer software instructions. When the instructions are executed by a communication apparatus, a function in any one of the foregoing method embodiments is implemented.

This application further provides a computer program. When the computer program is run on a computer, a function in any one of the foregoing method embodiments is implemented.

This application further provides a communication system. The system includes at least one first device and at least one second device in the foregoing aspects. In another possible implementation, the system further includes at least one model server in the foregoing aspects. In still another possible implementation, the system may further include another device that is in the solutions provided in this application and that interacts with the first device and the second device.

The foregoing embodiments may be wholly or partially implemented by using software, hardware, firmware, or any combination thereof. When software is used to implement the embodiments, the embodiments may be wholly or partially implemented in a form of a computer program product. The computer program product includes at least one computer instruction. When the computer instructions are loaded and executed on the computer, the procedures or functions according to embodiments of this application are wholly or partially generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device, for example, a server or a data center, integrating at least one usable medium. The usable medium may be a magnetic medium (for example, a floppy disk, a hard disk, or a magnetic tape), an optical medium (for example, a digital video disc (DVD)), a semiconductor medium (for example, an SSD), or the like.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A satellite communication method, wherein the method comprising:
receiving, by a first communication apparatus, first information having at least one first reference point and a frequency of at least one neighboring cell corresponding to the at least one first reference point, wherein
the at least one first reference point indicates a location in a first area other than a location of a network device to which the at least one neighboring cell corresponding to the at least one first reference point belongs, and the first area comprises a coverage area of the at least one neighboring cell corresponding to the at least one first reference point; and
measuring, by the first communication apparatus, the frequency of the at least one neighboring cell corresponding to the at least one first reference point in association with a location of the first communication apparatus is being within a distance range of the at least one first reference point.

2. The method according to claim 1, wherein measuring, by the first communication apparatus, the frequency of the at least one neighboring cell comprises:
measuring, by the first communication apparatus, a first frequency in association with a distance between the location of the first communication apparatus and the at least one first reference point being less than or equal to a first threshold corresponding to the first frequency, wherein the first frequency is within the frequency of the at least one neighboring cell corresponding to the at least one first reference point.

3. The method according to claim 2, wherein the at least one first reference point corresponds to a first frequency, and the first frequency corresponds to a first threshold.

4. The method according to claim 2, wherein the at least one first reference point corresponds to a plurality of frequencies, and
the plurality of frequencies correspond to a same threshold, or the plurality of frequencies correspond to at least two different thresholds.

5. The method according to claim 1, comprising:
receiving, by the first communication apparatus, second information having a second reference point, wherein
measuring, by the first communication apparatus, the frequency of the at least one neighboring cell comprises:
measuring, by the first communication apparatus, the frequency of the at least one neighboring cell corresponding to the at least one first reference point in association with the location of the first communication apparatus being within the distance range of the first reference point, and a distance between the location of the first communication apparatus and the second reference point being greater than or equal to a second threshold.

6. A satellite communication method, comprising:
sending, by a second communication apparatus, first information having at least one first reference point and a frequency of at least one neighboring cell corresponding to the at least one first reference point, wherein
the at least one first reference point indicates a location in a first area other than a location of a network device to which the at least one neighboring cell corresponding to the at least one first reference point belongs, and the first area comprises a coverage area of the at least one neighboring cell corresponding to the at least one first reference point.

7. The method according to claim 6, further comprising:
sending, by the second communication apparatus, second information having a second reference point.

8. The method according to claim 6, further comprising:
sending, by the second communication apparatus, third information having an opening angle using a third reference point as a vertex and using a reference direction as an angular bisector.

9. The method according to claim 6, wherein
the at least one neighboring cell, corresponding to the at least one first reference point, corresponds to a first beam in a neighboring cell of a satellite cell, and the first beam is used by the second communication apparatus to send the first information.

10. A communication apparatus, comprising:
at least one processor; and
one or more memories operatively coupled to the at least one processor, wherein the one or more memories store programming instructions that, when executed by the at least one processor, cause the communication apparatus to:
receive first information having at least one first reference point and a frequency of at least one neighboring cell corresponding to the at least one first reference point; and
the at least one first reference point indicates a location in a first area other than a location of a network device to which the at least one neighboring cell corresponding to the at least one first reference point belongs, and the first area comprises a coverage area of the at least one neighboring cell corresponding to the at least one first reference point; and
measure the frequency of the at least one neighboring cell corresponding to the at least one first reference point if a location of the communication apparatus is within a distance range of the at least one first reference point.

11. The communication apparatus according to claim 10, wherein the communication apparatus is further caused to:
measure a first frequency if a distance between the location of the first communication apparatus and the at least one first reference point is less than or equal to a first threshold corresponding to the first frequency, wherein the first frequency is within the frequency of the at least one neighboring cell corresponding to the at least one first reference point.

12. The communication apparatus according to claim 11, wherein the at least one first reference point corresponds to a first frequency, and the first frequency corresponds to a first threshold.

13. The communication apparatus according to claim 11, wherein the at least one first reference point corresponds to a plurality of frequencies, and
the plurality of frequencies correspond to a same threshold, or the plurality of frequencies correspond to at least two different thresholds.

14. The communication apparatus according to claim 10, wherein the communication apparatus is further caused to:
receive second information, having a second reference point; and
measure the frequency of the at least one neighboring cell corresponding to the at least one first reference point if the location of the communication apparatus is within the distance range of the first reference point, and a distance between the location of the communication apparatus and the second reference point is greater than or equal to a second threshold.

15. A communication apparatus, comprising:
at least one processor; and
one or more memories operatively coupled to the at least one processor, wherein the one or more memories store programming instructions that, when executed by the at least one processor, cause the communication apparatus to:
send first information having at least one first reference point and a frequency of at least one neighboring cell corresponding to the at least one first reference point, wherein
the at least one first reference point indicates a location in a first area other than a location of a network device to which the at least one neighboring cell corresponding to the at least one first reference point belongs, and the first area comprises a coverage area of the at least one neighboring cell corresponding to the at least one first reference point.

16. The communication apparatus according to claim 15, wherein the communication apparatus is further caused to:
send second information having a second reference point.

17. The communication apparatus according to claim 15, wherein the communication apparatus is further caused to:
send third information having an opening angle using a third reference point as a vertex and using a reference direction as an angular bisector.

18. The communication apparatus according to claim 15, wherein
the at least one neighboring cell, corresponding to the at least one first reference point, corresponds to a first beam in a neighboring cell of a satellite cell, and the first beam is used by the communication apparatus to send the first information.
